(19) United States
(12) Patent Application Publication
(10) Pub. No.: US 2025/0029309 A1
(43) Pub. Date: Jan. 23, 2025

(54) System for the creation and viewing of custom coded image animations

(71) Applicants: Ticha Melody Sethapakdi, Cambridge, MA (US); Rufus Butler Seder, Arlington, MA (US)

(72) Inventors: Ticha Melody Sethapakdi, Cambridge, MA (US); Rufus Butler Seder, Arlington, MA (US)

(21) Appl. No.: 18/763,759

(22) Filed: Jul. 3, 2024

Related U.S. Application Data
(60) Provisional application No. 63/527,639, filed on Jul. 19, 2023.

(51) Int. Cl. G06T 13/80; G03B 19/02; G03B 25/02; G06T 9/00

(52) U.S. Cl. CPC G06T 13/80; G03B 19/026; G03B 25/02; G06T 9/001

(57) ABSTRACT

A system for the creation and viewing of custom interlaced images with a camera lens, a digital camera unit, electronic memory, image processing computer software, and a shutter actuator retained by a camera body for selectively capturing images over a time period and creating interlaced images. Interlaced images can be created by automatically electronically slicing each of a plurality of images of a given image sequence and placing slices thus created in an interlaced sequence. Interlaced images are printed by a printer disposed within the camera body for viewing within a viewing device having an image decoding panel. Interlaced images can be viewed on a display screen retained by the camera body and then selected for printing. The viewing device has a biasing mechanism for biasing printed interlaced images into contact with the image decoding panel. Pre-animated, pre-interlaced scenes can be selectively merged with captured image sequences.

### RELATED APPLICATION

This application claims priority to U.S. Provisional Application No. 63/527,639, filed Jul. 19, 2023, which is incorporated herein by reference

### FIELD OF THE INVENTION

The present invention relates generally to imaging devices. More particularly, disclosed herein is a system for the creation of custom coded, interlaced images and for the viewing of those coded, interlaced images as custom animations.

### BACKGROUND OF THE INVENTION

Digital photography has experienced a surge in popularity. Continuing advancements in camera technology have spurred exponential growth in the number of photos captured. Digital photographs are easy to manipulate, reproduce, and share, all features that are valued in our increasingly connected world.

Simultaneously, the nostalgic appeal of instant-film analog cameras, such as those sold under the registered trademark POLAROID by Polaroid IP B.V. of the Netherlands, has reawakened. Despite the fact that instant cameras are more limited in their use and image quality as compared to digital cameras, there is a developing interest and need for innovative instant photographic solutions as new ‘old’ cameras continue to enter the market.

Photographs have traditionally been considered to be static. However, new forms of digital photography have challenged this convention, resulting in imagery that is more dynamic. The lines between still photos, videos, and animations have become blurred. Whereas moving photographs were once considered niche, major smartphone manufacturers, such as Apple and Google, have now devised of ways to integrate them into their newest photographic products.

While these examples focus on digital moving photographs, it is important to recognize that a number of analog animation techniques preceded the digital age. Once considered antiquated, these analog techniques, most notably barrier grid and lenticular animation techniques, have recently been rediscovered, improved upon, and applied to a number of successful products, including the worldwide best-selling children's animated books patented by one of the present inventors and sold under the registered SCANIMATION trademark, which is owned by the Rufus Butler Seder, LLC of Arlington, Massachusetts.

Barrier-grid animation, an animation display technique originated in the 1890's, is created by moving a striped transparent overlay across the surface of a printed scrambled image, which may alternatively be referred to as an interlaced or coded image since it is formed of slices from each of a plurality of different images. By the early 1900's, it was discovered that a similar scrambled image could be made to animate by substituting a transparent lenticular plate for the striped transparent overlay with brighter, clearer results. In a further improvement over the barrier grid, which must be physically moved over the scrambled image to cause the animation effect, the lenticular plate can be fixed to the scrambled image. The unified assembly can then simply be rocked back and forth, such as in the hand of the observer, to create the animation effect.

While these techniques may not offer the high frame rate of their digital successors, they come with unique affordances. Unlike digital moving images, which viewers passively experience on a display screen of a smartphone or tablet, barrier grid and lenticular animations require viewers to physically engage with the printed image to activate the display animation by, for example, manually sliding one layer over the other or by rocking the display back and forth. Such personal, hands-on personal interaction gives the user control over the speed and direction of motion, delivering a more intimate experience than is typically obtainable from digital devices.

As the market continues to grow for such analog animation displays, one major development has come in the form of systems and methods for permitting consumers to create their own coded images from pre-existing videos. However, such coded images typically must be subsequently created since there is a labor-intensive and time-consuming delay between capturing the motion, processing the images so obtained, and outputting the final coded image. Despite there being an increasing need and demand for the same as has been recognized by the present inventors, there has been no known system for instantly capturing, interlacing, and printing coded images in situ.

### SUMMARY OF THE INVENTION

With an appreciation of the foregoing limitations of the prior art and the challenges presented by systems for capturing and viewing motion of the past, the present invention is founded on the basic object of providing a system and method capable of providing and merging a capability to capture a series of live images with a capability to fabricate and display custom coded images derived from the series of live images immediately and automatically.

A more particular object of certain embodiments of the invention is to provide a system and method wherein the capabilities to capture live images and to fabricate and display custom coded images derived therefrom are merged into an easy-to-use, instantly-gratifying camera with printing capabilities capable of yielding custom coded images viewable in a separate, compact animation viewing device.

Embodiments of the system for custom coded image creation and the viewing of animations derived therefrom exploit an instant motion camera with analog viewing and image capture capabilities to capture a plurality of consecutive photos, to digitally process and encode the captured photos to yield an interlaced, coded image, and to produce inexpensive hard-copy prints instantly that can, with a small viewing device that forms part of the system, be caused to animate, such as in the user's hand. Thus, when a series of pictures are taken of, for example, a person waving her arm from side to side, the instant motion camera with analog viewing capability can process the plural images, produce a unified interlaced, coded image therefrom, and instantly print that interlaced, coded image. The resulting interlaced, coded image can then be inserted into a viewing device, such as a small lenticular viewer, and rocked by hand to cause the interlaced image to appear to come to life instantly.

The foregoing and further objects, advantages, and details of manifestations of the present invention will become obvious not only to one who reviews the present specification and drawings but also to those who have an opportunity to experience an embodiment of the instant motion capture camera with analog viewing system disclosed herein in operation. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

In one non-limiting practice of the invention, a photographer can first aim the camera at a subject about to perform an action, such as waving their hand from side to side, jumping up and down, or any other action or combination of actions. The photographer can then actuate the camera, such as by pressing a shutter button on the camera. An indication, such as a visual indication, an audible indication, or some other indication or combination thereof can be provided to the subject for a predetermined period of time, such as one second, by an action indicator triggered by the actuation of the camera. In certain practices, the action indicator could be an external indicator LED that illuminates for a set period of time, such as but not limited to one second, to cue the subject that the camera is capturing a brief video or a series of consecutive still images of the subject's action. The action indicator can automatically turn off when the photo, video, or other image capture is complete.

Computer software retained in electronic memory and processed by one or more electronic computer processors can then automatically select a specified number of images so captured, such as between three and six images. A resulting animation can then be created by electronically disposing the images in series to form an image sequence and displaying them, such as on a display screen of the camera. The computer software, electronic memory, and computer processors can be retained internally within the camera itself, or some or all of the computer software, electronic memory, or computer processing components can be remotely retained for operation by electronic wired or wireless communication. By operation of the computer software, the electronic memory, and the computer processor or processors, a coded, interlaced image is electronically produced. The coded, interlaced image is formed by consecutively disposed slices of the plurality of captured images selected.

An image printer is connected to the camera, potentially by being directly incorporated within the body of the camera as disclosed herein. When prompted by the user, the image printer prints a hard-copy of the coded, interlaced image. The coded image can, in certain practices, be printed onto thermal paper.

A viewing device is provided with an image decoding panel with image decoding elements. The image decoding panel can, for instance, be a lenticular panel with lenticles as decoding elements or a panel with shutter elements as decoding elements. The viewing device has a designated coded image receiving location, such as a slot, a channel, or any other receiving location. To ensure the optical clarity and impact of the resulting animation, the computer software used to interlace the selected images is calibrated to cause the pitch of the printed coded image to match the pitch of the decoding elements of the image decoding panel of the viewing device.

Under this construction, the printed coded, interlaced image can then be inserted into the viewing device. The custom coded image can then be caused to animate, such as by a rocking effect in the case of a viewing device with a lenticular panel. The camera, image printer, and viewing device can thus be considered to form a kit or system for obtaining, producing, and animating custom coded image animations.

Embodiments of the system for the creation and viewing of custom interlaced, coded image animations can be considered to be founded on a camera body. A camera lens is retained by the camera body as is a digital camera unit for capturing digital images through the camera lens. Electronic memory is incorporated for receiving digital images captured by the digital camera unit and for retaining image processing computer software to be processed with a computer processor. A shutter actuator retained by the camera body enables the selective capturing of images by the digital camera unit through the camera lens over a time period, and an indicator light on the camera can cue a subject regarding image capture by the digital camera unit. The image processing computer software and the computer processor are operative to process images captured by the digital camera unit over the time period to establish an image sequence comprising a plurality of images from among the images captured by the digital camera unit over the time period. The image processing computer software and the computer processor are further operative to create an interlaced, coded image from the plurality of images of the image sequence with the interlaced, coded image comprising interlaced slices of the plurality of images of the image sequence.

The interlaced, coded image is adapted to be printed, such as by a dedicated printer incorporated into the camera body, to create a printed interlaced, coded image. The printer can, by way of example and not limitation, comprise a thermal printer for printing interlaced, coded images on a roll of printing substrate passed through the printer. In embodiments of the system, first and second end caps rotatably retain rolls of printing substrate for use by the printer. Each end cap can comprise a guide surface positioned to be disposed to guide an edge of the roll of printing substrate, and the system can further comprise an exit guide positioned to guide edges of the roll of printing substrate as it exits the printer.

A display screen is retained by the camera body. The image processing computer software, the computer processor, and the display screen are operative to create and display interlaced, coded images created by the image processing software and the computer processor from image sequences of images captured by the digital camera. In certain embodiments, an image decoding panel with image decoding elements, such as lenticles or shutter elements, can be retained atop the display screen for decoding coded images displayed on the display screen. Moreover, within the scope of the invention, the image processing computer software, the computer processor, and the display screen can be operative to create and selectively display plural different interlaced, coded images based on image sequences comprising at least some different images or differently ordered images from among the images captured by the digital camera unit over the time period. With that, a user can manually select from among the plural different interlaced, coded images for printing by use of the integrated printer. Of course, it is also within the scope of the invention for the image processing computer software, the computer processor, and the display screen to cooperate to display non-coded animations on the display screen prior to printing without the need for an image decoding panel with the non-coded animations depicting how resulting interlaced, coded images would animate once printed and installed in a viewing device.

Where the system includes a viewing device for receiving printed, interlaced coded images, the viewing device has an image decoding panel for decoding printed, interlaced coded images. For instance, the viewing device can comprise a front structure with the image decoding panel and a rear structure. The front structure and the rear structure are adapted to receive printed interlaced, coded image in a slot therebetween, and a biasing mechanism biases printed interlaced, coded images into contact with the image decoding panel of the front structure. Manifestations of the viewing device can include a support rail disposed to traverse longitudinally between the front and rear structures with the support rail being operative to support and X/Y orient printed interlaced, coded images in relation to the image decoding panel of the viewing device. Furthermore, the viewing device can have serrated edges for permitting any protruding edges of printed, interlaced coded images to be torn away. Where the viewing device is considered to have left and right edges spaced by a given distance, the image processing computer software, the computer processor, and the printer can cooperate to print alignment lines prior to and after printed, interlaced coded images. The alignment lines are spaced in correspondence to the given distance between the left and right edges of the viewing device. With that, printed, interlaced coded images can be readily centered relative to the viewing device.

The interlaced, coded images are adapted by the image processing computer software and the computer processor to be printed onto a printing substrate that has first and second parallel edges. In particular practices of the invention, the interlaced slices of the plurality of images of the image sequence can be disposed on an angular bias, such as approximately 10 degrees, away from horizontal in relation to the edges of the printing substrate for optimal printing and viewing characteristics.

It is further disclosed herein to have pre-animated, pre-interlaced scenes stored in the electronic memory of the camera with the image processing computer software being operative to selectively merge the pre-animated, pre-interlaced scenes with the image sequence captured by the digital camera unit. A user can thus select from pre-animated, pre-interlaced scenes and from differing interlaced, coded images captured by the camera with the image processing computer software automatically integrating the selected pre-animated, pre-interlaced scenes with the selected interlaced, coded images.

Further still, it is taught herein that users could be provided with the option of additionally or alternatively printing coded, interlaced images by use of a separate printer, such as a home or office printer, to produce additional image prints that could potentially be of higher quality or greater size than those rendered by the printer integrated into the camera of the present invention. Such printing could be accomplished by transferring coded, interlaced images retained in electronic memory of the camera to the home, office, or other printer, whether by a wired or wireless data connection, by use of an electronic memory medium, or by any other effective mechanism.

Embodiments of the system are disclosed wherein the image processing computer software and the computer processor are operative to create an interlaced, coded image from the plurality of images of the image sequence by automatically electronically slicing each of the plurality of images of the image sequence and placing slices of the plurality of images in an interlaced sequence. Moreover, the image processing software and the computer processor can be operative to rotate each of the plurality of images of the image sequence by a given angular bias in a first rotational direction prior to electronically slicing each of the plurality of images of the image sequence, then to automatically electronically slice each of the plurality of images of the image sequence and to place slices of the plurality of images in an interlaced sequence, and then to re-rotate the interlaced, coded image so created in a second rotational direction opposite the first rotational direction over the angular bias. Further still, the image processing computer software and the computer processor can be selectively operative to apply an automatic looping algorithm to the plurality of images of the image sequence to provide for smoother animation of the captured images.

One will appreciate that the foregoing discussion broadly outlines certain goals and features of non-limiting embodiments of the invention to enable a better understanding of the detailed description that follows and to instill a better appreciation of the inventors' contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

The present invention will be described and explained with additional specificity and detail through reference to the accompanying drawings, wherein:

FIG. 1 is an anterior perspective view of a system for coded image creation and the viewing of animations derived therefrom according to the present invention;

FIG. 2 is a posterior perspective view of the system of FIG. 1;

FIG. 3 is a view in front elevation of components of the camera disclosed herein;

FIG. 4 is a flow chart depicting the interrelationships between components of the camera;

FIG. 5 is a more detailed flow chart depicting the interrelationships between components of the camera;

FIG. 6 is an electrical diagram of an embodiment of the system;

FIG. 7 provides further perspective views of the camera disclosed herein;

FIG. 8 is an amplified perspective view of the display screen and certain controls of the camera;

FIG. 9 comprises top plan views of components of the camera;

FIG. 10 is a schematic top plan view of printers printing image slices perpendicular to the path of travel of the printing substrate through the printers;

FIG. 11 is a schematic top plan view of printers printing image slices parallel to the path of travel of the printing substrate through the printers;

FIG. 12 comprises top plan views of an original digital image file above a thermally printed image above such an image viewed through an image decoding panel;

FIG. 13 comprises schematic views of the effects of printing interlaced images at differing angles;

FIG. 14 comprises further schematic views of the effects of printing interlaced images at differing angles;

FIG. 15 is a view in front elevation of a viewing device according to the present invention;

FIG. 16 comprises schematic views of the effects on visual perception of printing interlaced images at differing angles;

FIG. 17 comprises views in front elevation of series of original images, of sliced images, and of interlaced images deriving therefrom:

FIG. 18 is a view in front elevation of a viewing device according to the present invention with an interlaced image retained therein for animation and viewing:

FIG. 19 comprises views in front elevation of interlaced images printed according to the invention;

FIG. 20 comprises perspective views of a roll of substrate for use in printing according to the invention with end caps for promoting accurate alignment;

FIG. 21 comprises perspective views of a roll of substrate applied to a printer according to practices of the invention;

FIG. 22 comprises perspective views of a printer according to an embodiment of the invention with the application of a paper guide;

FIGS. 23A through 23F comprise perspective views of an alternative viewing device as disclosed herein;

FIG. 24 comprises views in side elevation of the viewing device of FIGS. 23A through 23F in assembled form during insertion of an interlaced image;

FIG. 25 comprises perspective views depicting alignment of an interlaced image in a viewing device;

FIG. 26 comprises perspective views depicting the detaching of excess segments of the interlaced image panel using serrated edges of the viewing device;

FIG. 27 comprises a perspective view depicting the seating of the interlaced image panel within the viewing device;

FIG. 28 comprises perspective view depicting the removal of an interlaced image panel from the viewing device;

FIGS. 29A through 29C comprise perspective views of another alternative viewing device in stages of assembly;

FIG. 30 comprise a schematic view in front elevation of a lenticular panel applied over an interlaced image;

FIG. 31 comprise a schematic view in front elevation of a lenticular panel applied over an interlaced image with a spacing element interposed therebetween;

FIG. 32 comprises perspective views of an image decoding panel being applied to a camera according to the invention;

FIG. 33 comprise a schematic view in front elevation of a lenticular panel alternatively applied over an interlaced image with a spacing element interposed therebetween:

FIG. 34 comprises perspective views of an image decoding panel being applied to a camera with a spacing panel therebetween according to the invention:

FIG. 35 comprises views in front elevation of original images being combined with pre-animated scenes according to embodiments of the invention;

FIG. 36 comprises views in front elevation of original images being combined with pre-animated scenes according to embodiments of the invention;

FIG. 37 comprises views in front elevation of images being reordered according to the disclosed invention;

FIG. 38 comprises perspective views of a further viewing device in stages of assembly:

FIG. 39 is a schematic top plan view of an alternative system as disclosed herein;

FIG. 40 is a perspective view of a monitory for use with the system of FIG. 39;

FIGS. 41A through 41F comprises perspective views of still another viewing device in stages of assembly;

FIGS. 42A through 42E comprises perspective views of an interlaced image being inserted into and aligned with a viewing device pursuant to the invention; and

FIG. 43 comprises a top plan view of a paper sheet printed with a coded image according to a practice of the present invention.

### DETAILED DESCRIPTION OF PREFERRED EMBODIMENTS

The present invention for a system for custom coded image creation and the viewing of animations derived therefrom could pursue widely varied embodiments. However, to ensure that one skilled in the art will be able to understand and, in appropriate cases, practice the invention, certain preferred embodiments of the broader invention revealed herein are described below and shown in the accompanying drawing figures. These embodiments are intended to be illustrative but are not intended to be limiting in any manner.

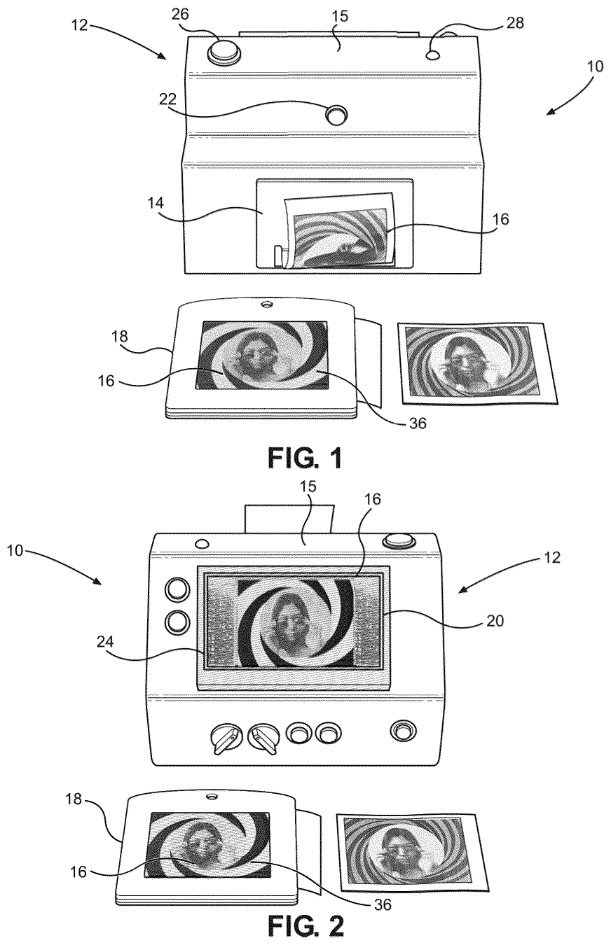

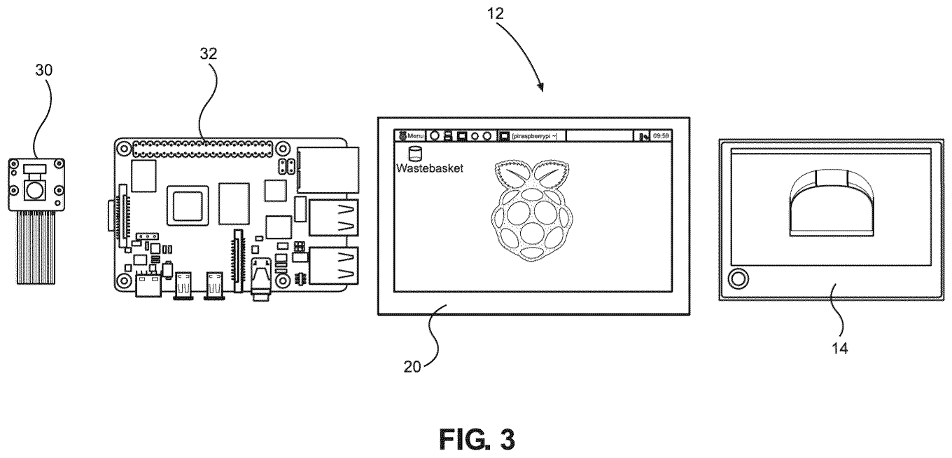

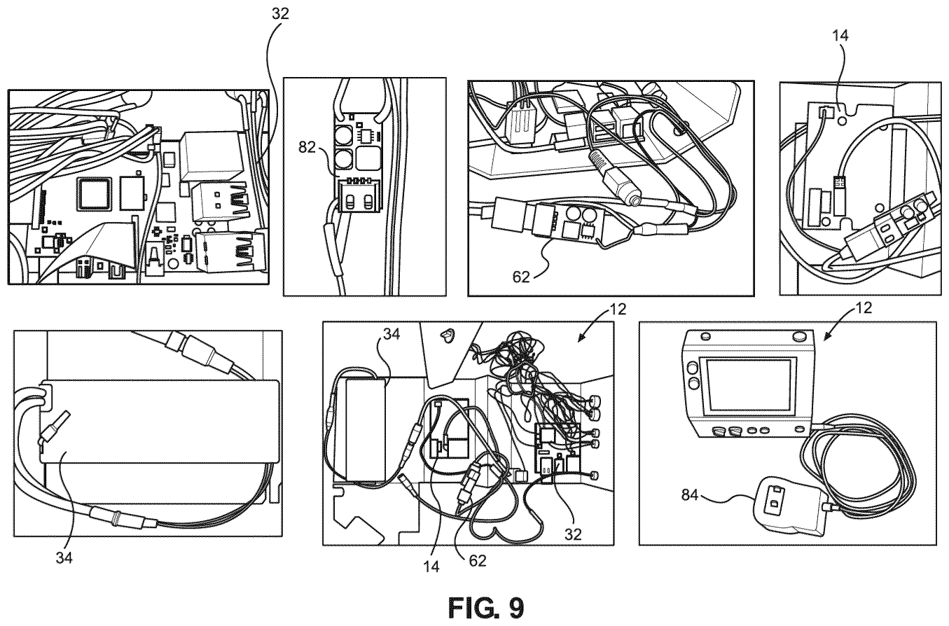

Turning more particularly to the drawings, an embodiment of the system for custom coded image creation and the viewing of animations derived therefrom is indicated generally at 10 in FIGS. 1 and 2. There, the system 10 can be considered to be founded on a camera 12 and a viewing device 18. The camera 12 can, for instance, be a battery-operated camera 12. The camera 12 has a camera housing or body 15. A lens 22 is retained by the camera body 15 facing anteriorly, and a display screen 20, such as an LCD display screen 20, is retained by the camera body 15 facing posteriorly. In this preferred embodiment, an image-decoding panel 24, such as a lenticular panel 24 or a panel 24 with shutter elements applied thereto, is affixed directly and permanently overlying the display screen 20 for previewing and animating coded, interlaced images obtained and produced by the camera 12, such as by a rocking back and forth, prior to printing. As shown, for instance, in FIGS. 3 and 9, the camera body 15 houses electronic memory retaining dedicated, pre-programmed image processing computer software and one or more computer processors 32. The camera 12 includes further electronic components, including a mini printer 14. The mini printer 14 can, by way of example and not limitation, comprise a black and white thermal printer.

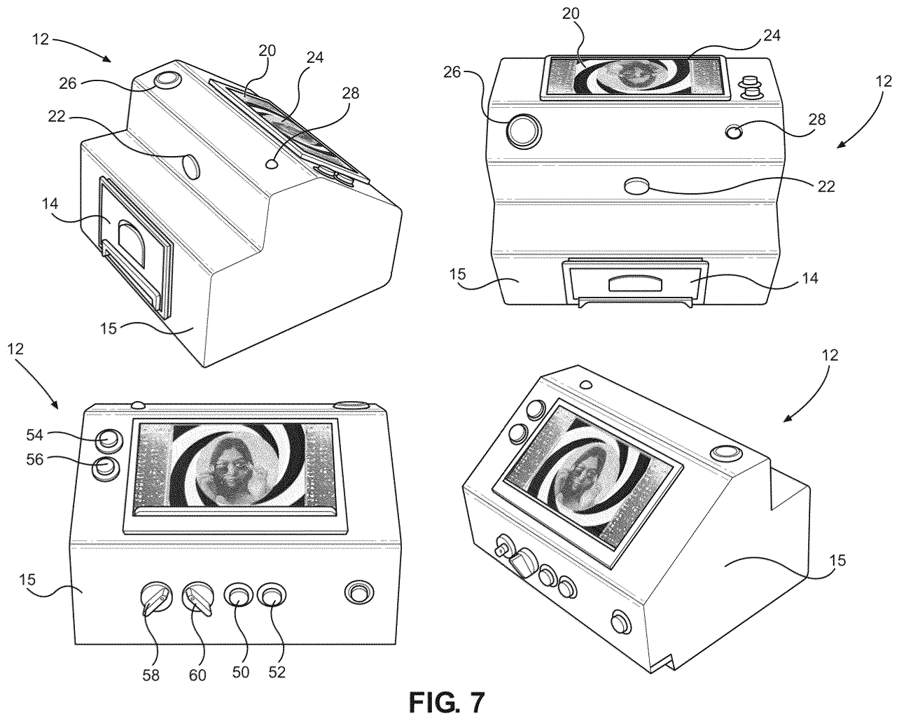

As shown, for instance, in FIG. 7, the camera body 15 of the camera 12 retains a shutter button 26, print and other buttons and controls 52 through 60 for causing a printing of coded images 16 and for adjusting, for example, image brightness, contrast, and potentially other characteristics. Further, differently colored external indicators, such as LED indicator lights 28 or, more particularly, an RGB indicator LED light 28, retained by the camera body 15 can cue the subject being photographed shortly before images are obtained by the camera 12 and during the obtaining of images. For instance, when the shutter button 26 is pressed to activate the image capturing process of the camera 12, a yellow LED indicator light 28 can flash, such as three times, to warn the subject that the images are about to be taken. Then, a bright blue LED indicator light 28 can illuminate continuously, such as for one full second, while the images are actually being captured by the camera 12. Audible sound cues, such as three short beeps and one long beep, could additionally or alternatively be employed for warning of the impending capture of images and notifying of the concomitant capture of images by the camera 12.

The system 10, which may alternatively be considered a kit 10, further comprises a viewing device 18, which can be physically separate from the camera 12. The viewing device 18 can, for instance, comprise a small lenticular photo viewing device 18 with a lenticular image decoding panel 36. A coded, interlaced image 16 produced and printed by the camera 12 can thus be animated, such as by a manual rocking back and forth where the image decoding panel 36 comprises a lenticular panel 36. Alternatively, where the viewing device 18 retains a shutter element image decoding panel 36, animation of a coded, interlaced image 16 produced and printed by the camera 12 can be achieved by producing a relative sliding of the shutter element image decoding panel 36 of the viewing device 18 relative to the coded, interlaced image 16. In certain non-limiting embodiments as shown and described further herein, the viewing device 18 can take the form of a typical keychain photo frame with a slot, channel, or other receiving formation into which a custom interlaced image 16 can be inserted for animation by the viewing device 18.

Certain core components retained by or within the camera body 15 of the camera 12 can be perceived with reference to FIG. 3. There, the camera 12 can be seen to incorporate from left to right in the drawing a high-resolution digital camera unit 30, a main computer processing unit 32, an LCD display screen 20, and a thermal printer 14. The digital camera unit 30 is operative to capture images, such as through high-resolution video, presently 1920×1080 pixels for example, or through the capture of consecutive still images. Under present technology, an eight megapixel camera unit 30 has been found to provide sufficient image resolution while being capable of operating at a high processing speed. The main processing unit 32 is operative to select a plurality of images captured by the camera unit 30 and to process the obtained images to create a coded image 16, sometimes referred to as a set of scrambled images or an interlaced image, comprising slices of the obtained images.

The displayed and printed interlaced, coded image 16 may not be immediately recognizable when viewed with the naked eye. This coded image 16 is an electronically-produced combination of slices of the selected phases of images captured by the digital camera unit 30 of the camera 12 placed side by side in series to yield what might be described as image clusters. The pitch, or size, of each image cluster, typically spanning laterally across the coded image 16, is designed to match exactly the pitch of each image decoding element of the image-decoding panel 36 and of the viewing device 18 with it being noted that the image decoding elements of a lenticular viewing device 18 will comprise lenticular lenses. To create the coded, interlaced image 16 digitally, the software operating on the camera 12 processes the captured original images, selects staggered portions from each image, and merges them together into the coded image 16 with slices of sequential images disposed in repeating series. One complete series of adjacent image slices may be referred to as an image cluster.

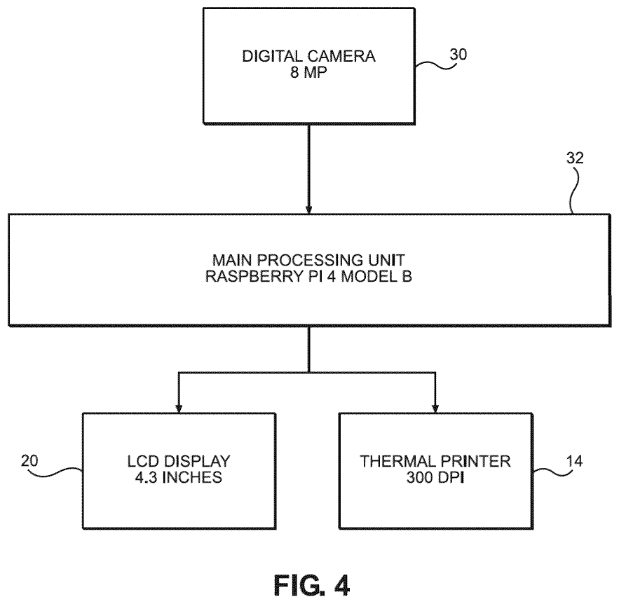

The coded image 16 so produced is displayed on the display screen 20. The dimensions of the displayed coded image 16 can be caused by the camera 12 to match those of a resulting hard copy coded image 16 printed by the printer 14. With that, the displayed coded image 16 can be viewed in full animation through the image decoding panel 24 of the display screen 20 prior to printing. In current embodiments of the system 10, a Raspberry Pi 4 Model B processing unit 32 is employed with 8 GB of memory and Wifi/Bluetooth connectivity. The flow diagram of FIG. 4 schematically shows the main hardware components of the camera 12 and certain interconnections of those components.

The image decoding panel 24 affixed to overlie the display screen 20 thus facilitates the display and animation of the displayed coded image 16. The image decoding panel 24 can comprise, for example, a lenticular panel or a shutter element panel. The pitch and other dimensional and optical characteristics image decoding panel 24 can match those of the image decoding panel 36 of the viewing device 18. In preferred embodiments, the image decoding panel 24 of the camera 12 and the image decoding panel 36 of the viewing device 18 comprise lenticular sheets with lenticles disposed at a 10-degree angle as further shown and described herein. Manifestations of the invention incorporate, for instance, a 4.3-inch LCD monitor display screen 20 to display images of the same physical dimension as the coded images 16 printed by the printer 14. The camera 12 provides image adjustment and selection capabilities, such as selector switches, push buttons, or graphic user interface elements on the display screen 20, that permit a user to view and adjust displayed coded images 16 until desired obtained images are found for printing.

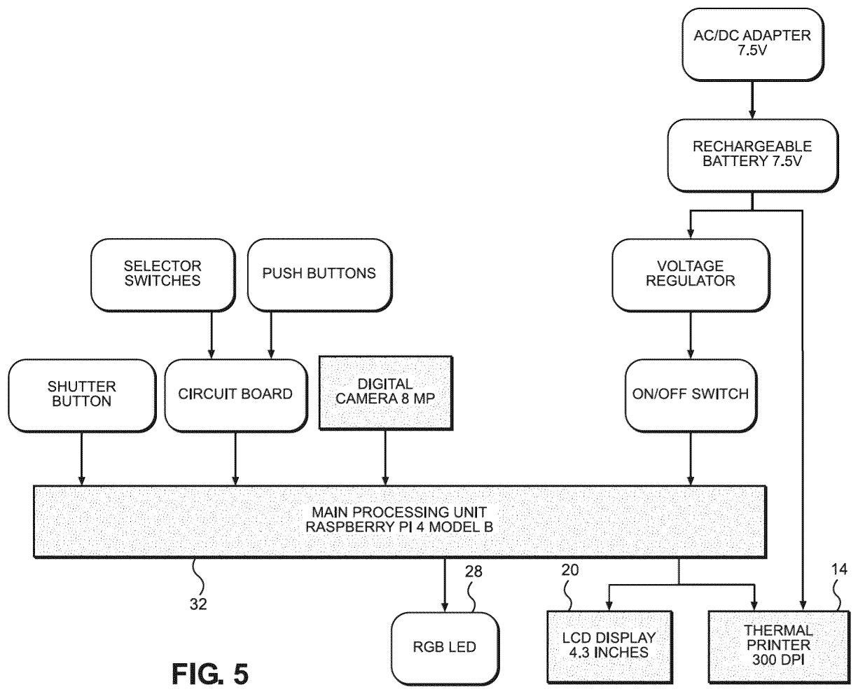

With further reference to FIGS. 5 and 9, the thermal printer 14 incorporated into the camera 12 and retained by or partially or entirely within the camera body 15 electronically receives a diffusion dithered coded image 16 from the main computer processing unit 32. The printer 14 is then operative to print out the selected, custom coded image 16, such as in a landscape orientation. It has been found that a typical thermal printer 14 can operate in a 5-9 voltage range, and a 7.5V battery 34 retained by the camera 12 has been identified as providing an optimal supply voltage. The selected battery 34 is a high capacity battery 34, such as a 7.5V battery 34, and is operative as the main power source for the camera 12. A voltage regulator 82 is used to convert the 7.5V power supply of the battery 34 to a 5V power supply for the main processing unit 32, the camera unit 30, the display screen 20, and each of the remaining electronic components other than the thermal printer 14. The battery 34 can be rechargeable, such as by a 7.5V AC/DC adapter 84 in the present embodiment.

A small circuit board connects the peripheral electronic components, including each indicator light 28, selector switches, push buttons, and other components, to the main processing unit 32. The circuit board provides pull-up and pull-down resistors for proper electronic connections between the peripheral components and the main processing unit 32. As shown, for instance, in FIG. 5, electronic selection switches and momentary push buttons provide electronic user interaction with the camera 12 for image selection and manipulation functions. An ON/OFF latching power switch is operative turn the camera 12 on and off.

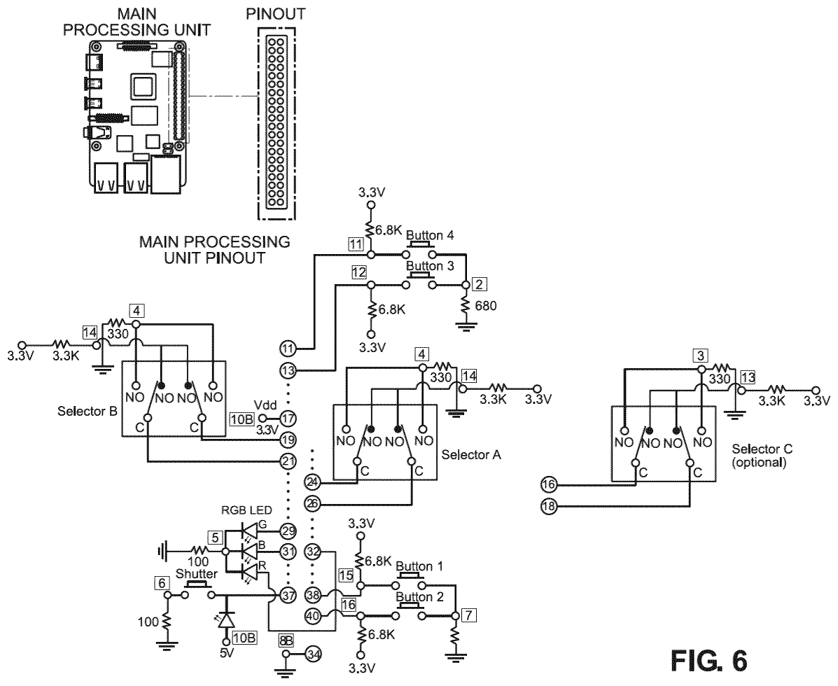

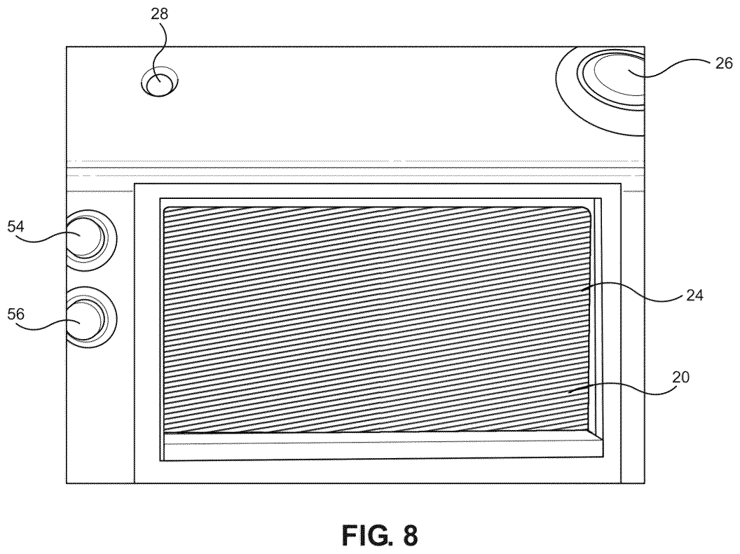

FIG. 6 provides a diagram of the hardware components of the camera 12 and their interconnections, and FIGS. 7 and 8 show the camera 12 itself. Selector A 58 is operative to enable a selection of a prefabricated overlay image to be included in the coded, interlaced image 16. Selector B 60 has three positions in combination with Buttons 1 & 2 50 and 52 with the first being Animation Sequence—Scroll through the possible animation sequences, the second being Brightness Adjustment: Button 1 50—brighter; Button 2 52—darker; and the third being Contrast Adjustment: Button 1 50 more contrast; Button 2 52 less contrast. Buttons 1 & 2 50 and 52 are used in combination with the selector switches. Button 3 54 is operative to induce a printing of the displayed image 16, and Button 4 56 causes a return to image capture mode. Each selector and button 50 through 60 is retained by the camera body 15 or access by a user.

With additional reference to FIG. 9 where inner workings of the camera 12 are shown, the printer 14, which can be a 200 dpi thermal printer 14, is connected to the main processing unit 32 through one of four USB connector ports 62. A keyboard, mouse, and SSD can also be connected to the main processing unit 32 through a USB port 62, such as during software installation, updating, or development. External connections to the USB port or ports 62 are not needed during normal camera operation, and the USB port or ports 62 need not be accessible to end users and could be excluded from final commercial embodiments of the system 10.

In one preferred embodiment, the camera 12 is disposed in ‘capture mode’ at the start of operation. To capture images, the user presses and releases the shutter button 26. When the user releases the shutter button 26, the indicator light 28 will turn yellow and provide a warning signal, such as by blinking 3 times, indicating that the camera 12 is about to record the motion of a subject. The camera 12 then enters an image capture mode for a predetermined time period, and the indicator light 28 can then provide an image capture signal, such as by illuminating in a blue illumination mode for what can be a predetermined time period, such as one full second, as the camera 12 records motion of the subject.

Once the computer processor 32 of the camera 12 processes the images so recorded, the camera 12 enters an ‘edit mode’ and shows a scrambled or interlaced image 16 produced from a plurality of recorded images on the display screen 20. From there, the user can perform a plurality of imaging steps. For instance, the user can preview the sequence of captured images to be animated with the interlaced image 16, such as by placing the supplied image decoding panel 24 on the display screen 20 and rocking the camera 12 back and forth. The image decoding panel 24 can be fixed in place to overlie the display screen 20, or the image decoding panel 24 could be removable and replaceable. The user can additionally actuate an electronic display of a first animation sequence of captured images used to create the interlaced image 16, such as by adjusting Selector B 60 to Position 1. The user can actuate an electronic display of a second animation sequence of captured images, such as by actuating Button 2 52, and the user can revert to a display of the first animation sequence of captured images by actuating Button 1 50. The user can also adjust the brightness of the interlaced image 16, such as by adjusting Selector B 60 to Position 2 and decreasing the brightness with Button 1 50 or increasing the brightness with Button 2 52. Further, the user can adjust the contrast of the interlaced image 16 by turning Selector B 60 to Position 3. The user can then decrease the contrast with Button 1 50 or increase the contrast with Button 2 52. Still further, a user can apply an overlay image to the interlaced image 16 by selecting from overlay images retained in electronic memory with Selector A 58. When the user is satisfied with the displayed interlaced image 16, the user can press Button 3 54, which triggers a printing of the interlaced image 16 by the printer 14. When desired, the camera 12 can be returned to image capture mode, such as by a pressing of Button 4 56.

The description above serves as a non-limiting example of how the camera 12 can be operated by a user. However, it will be understood that the user interface and operations can be modified, reorganized, supplemented, or streamlined to suit manufacturing and performance preferences. Further or additional manual adjustments and controls may be permitted, and certain characteristics can be partially or completely automated.

The camera 12 is capable of producing sharp, fluidly animating prints at a low cost. For example, in one embodiment, the displayed animation provided by the interlaced image 16 by the camera 12 and printer 14 employs six animation frames, which provide a more fluid animation than, for example, only three or four animation frames. The printer 14 of the camera 12 can be chosen to produce black and white thermal prints, which cost a small fraction of the cost of instant color prints, at as high a printed resolution as possible, such as at 300 dpi rather than 200 dpi. Further, the separate viewing device 18 is preferably a lenticular viewer 18 with an image decoding panel 36 having a sufficient number of micro lenses per inch (LPI), such as 40, to deliver bright animated images of appreciable resolution and clarity. In this regard, a lenticular viewing device 18 may be preferred over a barrier grid viewing device 18 since barrier grid devices often produce dark, low resolution animated images while requiring manual sliding of one piece over another for animation.

To enhance the perceived clarity of the printed image 16 further and thus the animation it displays, it is preferable that the printing software installed in the electronic memory of the camera 12 or otherwise operable on the camera 12 be assigned to print photos with a natural looking “diffusion dithering” dot pattern, such as the Floyd/Steinberg dot pattern. This may be preferable to the more regimented “pattern dithering” dot pattern.

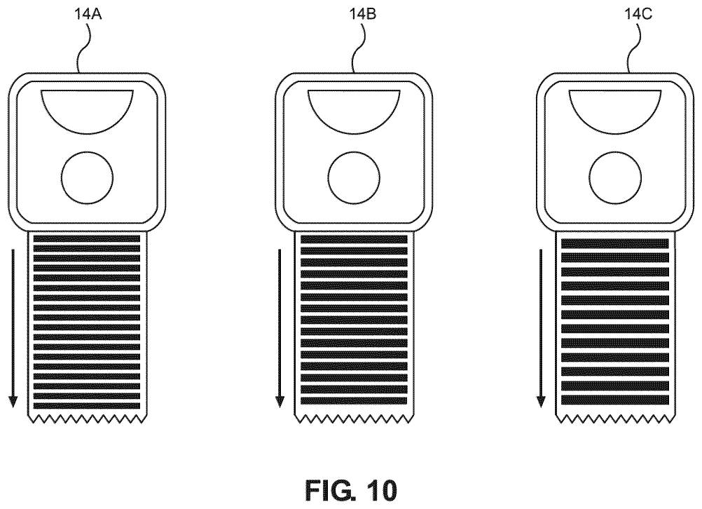

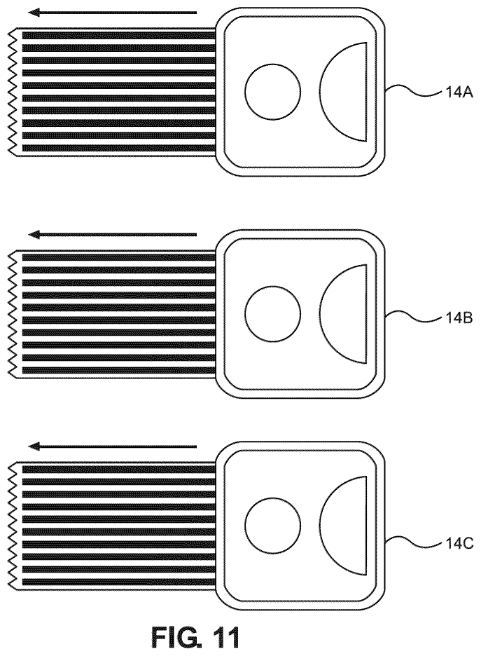

The inventors have determined that, for best results, photos taken with the camera 12 should preferably be captured and printed in landscape, rather than in portrait, mode. In this regard and with reference to FIGS. 10 and 11, it is noted that, to obtain the clearest animation effect, it is necessary that the long, thin, lenses of a lenticular plate image decoding panel 24 or 36 be oriented horizontally rather than vertically. This horizontal bias ensures that, as the display is made to animate, the observer's two eyes will each simultaneously see the exact same animation phase at one time, resulting in a clear and convincing animation effect. Conversely, if the lenses are oriented vertically, each of the observer's two eyes will likely see a different phase image simultaneously, confusing the clear perception of the animation.

Furthermore, while a horizontally-biased lenticular plate image decoding panel 24 or 36 can be applied to a portrait mode photo where the image slices of the interlaced image 16 are perpendicular to the path of travel of the printing substrate through the printer 14, the inventors have learned that landscape mode is preferable in applications of the system 10 using a mini black-and-white thermal printer 14, which typically employ a motor-driven rubber roller that transports paper past a heated, stationary printing head before ejecting it from the printer 14. Depending on factors including the power of the battery 34 at any one given time, the printer motor may vary slightly in speed from print to print. Even if the power supplied could be made to be dependably constant, it has been found that supposedly identical motors in identical model printers, such as those indicated at 14A, 14B, and 14C in FIGS. 10 and 11, can vary slightly in speed from one to the other. As is suggested by FIG. 10, this unpredictability of speed between printers 14A, 14B, and 14C can cause inconsistent “image stretch” of the printed image 16 in the direction that the print is being transported beneath the print head. Thus, the length of the printed image 16 may vary slightly from print to print in a given printer 14A. 14B, or 14C or from duplicate printer to duplicate printer 14A, 14B, or 14C.

Ideally, each of the horizontal scrambled image clusters of the interlaced image 16 would be proportioned to fit exactly beneath each of the horizontal lenses of the image decoding panel 36 of the viewing device 18 to display one whole single image phase to both eyes when the displayed interlaced image 16 is held motionless and viewed at a typical hand-held distance of 15 to 18 inches. However, even though the computer software of the camera 12 is written to match the pitch of the printed coded image 16 exactly with the pitch of the image decoding panel 36 of the viewing device 18, the promise of this desired match-up between the image decoding lenses and the image 16 when printed in portrait mode may be defeated by such unpredictable image stretch. It is worth noting that even image stretch that is small enough to be invisible to the naked eye may still be sufficient enough to prevent a portrait-oriented printed image 16 from lining up with the image decoding elements and animating clearly when viewed through the lenticular plate 36 of the viewing device 18.

As FIG. 11 illustrates, when the image clusters are printed in landscape mode in alignment with the path of travel of the printing substrate through the printer 14A, 14B, or 14C, however, they traverse in the same direction as the paper through the printers 14A, 14B, and 14C. As a result, image stretch does not adversely affect consistent spacing between printed lines, including from duplicate printer model to duplicate printer model since the spacing of the lines printed in this orientation will be unaffected by the speed of the motorized roller of different printers 14A, 14B, and 14C.

From the discussion above, one might reasonably conclude that landscape printing alone will suffice to produce coded or scrambled images that will animate acceptably well in the lenticular viewing device 18. However, within the scope of the invention, it is contemplated that the slices of the coded images 16 and the image decoding elements of the image decoding panel 24 affixed to the camera 12 and the image decoding panel 36 of the viewing device 18 may preferably be disposed along an angular bias. In this regard, it will be noted that, in traditional animated lenticular displays, interlaced images and image decoding elements are normally arranged in a strictly horizontal manner so that, when the image is looked at in the lenticular viewer, both of the observer's eyes will perceive the same animation phase at the same time. However, for manifestations of the present invention, an angular tilt or bias of the coded image 16 and the image decoding elements away from horizontal, such as at approximately 10 degrees, is preferable.

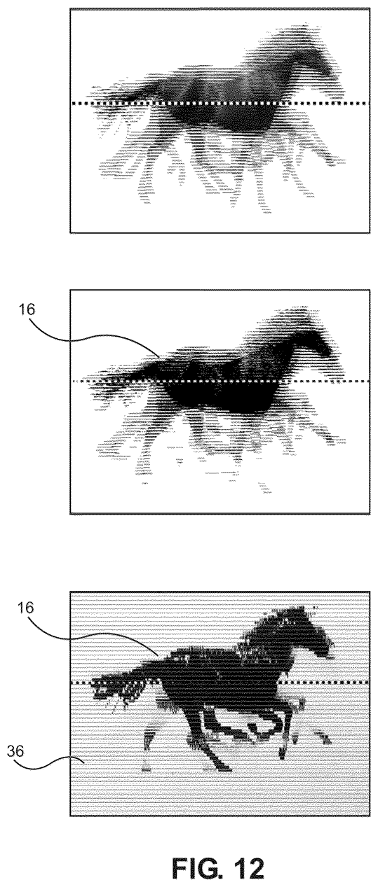

One advantageous aspect of such a bias under the present invention is that the low dot-per-inch resolution (e.g., 200 dpi or 300 dpi) of current thermal printers 14 cannot consistently resolve and print accurate horizontal line widths called for by the software's internal digital file. With horizontally disposed image slices, line thickness will tend to vary unacceptably, even to the point of missing lines, rather than being formed with image clusters and slices of images within those clusters of consistent, reliable thickness. When such horizontally disposed interlaced images are placed in a similarly horizontally-biased lenticular viewing device as taught by the prior art, the resulting image displayed is either a choppy-looking animated image, or, worse yet, an image display with more than one animation phases displayed in a mixed, confusing manner simultaneously. This phenomenon is shown, for instance, in FIG. 12 where the original digital image file is depicted above the actual thermal printed image 16, which in turn is disposed above the printed image 16 when viewed through a lenticular plate 36. There, a six-phase interlaced image 16 is designed to include forty image clusters per inch with each image cluster containing six image slices of equal thickness. Thermal printers printing at 200 or 300 dpi, for instance, cannot resolve the digital image. This results, as in the middle illustration, in horizontal image lines of the printed coded image 16 of unequal thickness and even with certain areas of the image failing to print. As a result, when the printed coded image 16 is viewed through a lenticular plate 36 as in the lowest illustration, the animation phases appear choppy and indistinct, mixing together and compromising the animation effect.

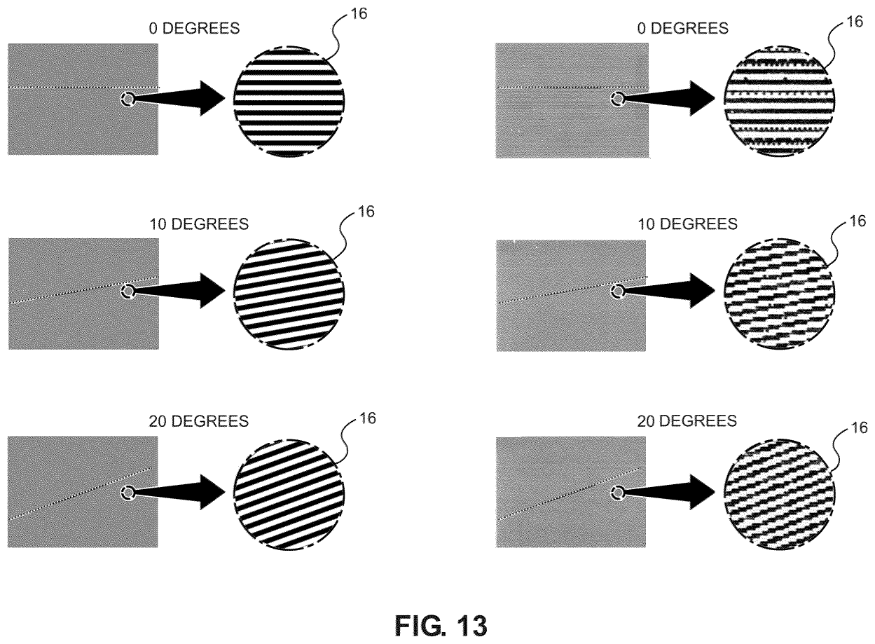

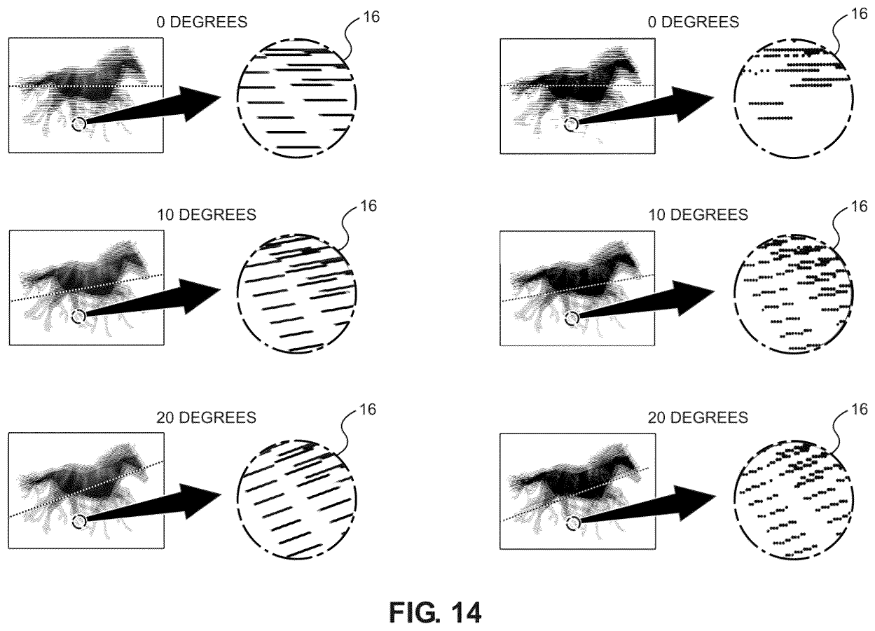

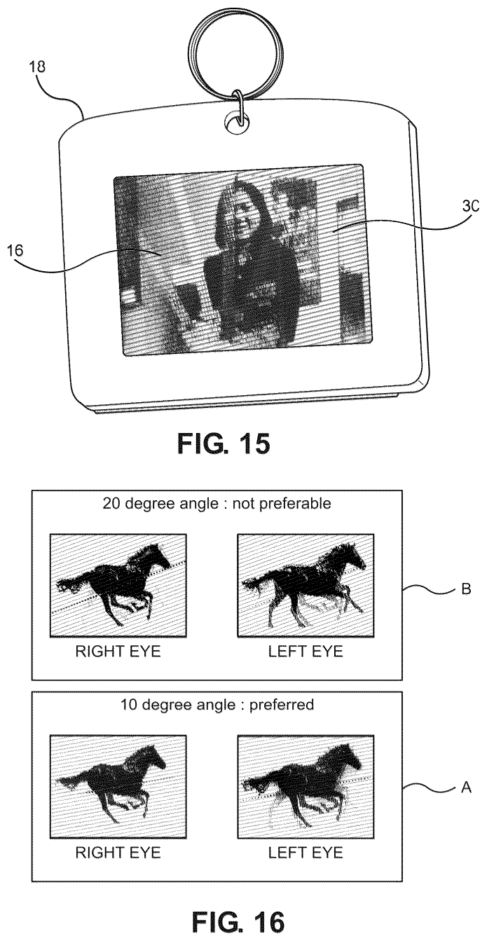

With reference to FIGS. 13 through 15, it has been discovered in relation to the present invention that the solution to this problem lies in changing the traditional angular bias of the interlaced image 16 and the image decoding elements of the image-decoding panel 36 of the viewing device 18 from a strictly horizontal angle to a slight diagonal angle. In FIG. 13, the original digital graphics of the interlaced images 16 are depicted in the left-hand column while the resulting printed graphics of the interlaced images 16 are depicted in the right-hand column. Diagonal angles of the interlaced image 16 of 10 and 20 degrees away from horizontal are depicted as examples below horizontal interlaced images 16. When such slight diagonal biases are incorporated, the thickness of the printed lines comprising the interlaced, coded image 16 as actually printed immediately reclaim the consistency of width contemplated by the original digital file of the interlaced image 16. A smooth, clean animation effect is thus produced.

It will be noted that, although the printed lines in a 10-degree angle coded image 16 are acceptably consistent in width, they are necessarily composed of “steps” created by the printed dots since these lines are not strictly horizontal. These “steps” unavoidably, albeit slightly, overlap into the areas of neighboring lines, causing a slight ghosting of one animation phase over the other when viewed through the image decoding panel 36 of the viewing device 18. Because this printed cross talk is more pronounced in a 200-dpi print than a 300-dpi print, a 300-dpi printer 14, while not absolutely essential to this invention, is certainly more preferable than a 200-dpi printer 14.

Because an angle steeper than 10 degrees can further reduce printed cross talk between lines, one might reasonably assume that a 20-degree or an even steeper angle will deliver cleaner animations to the eye. However, there is another factor that must be taken into account, namely binocular cross talk, as can be understood with further reference to FIG. 16. As mentioned previously, for lenticular animation to perform optimally, it is preferable that both of the observer's eyes see the same animation phase at the same time. If one eye were to see one animation phase and the other to simultaneously see a different animation phase, visual confusion would occur, and the animation effect would be compromised.

It is known that the pupillary distance between human eyes typically measures between 54 mm-68 mm (2⅛″-2 11/16″). It is also known that a small, hand-held display, such as the viewing device 18 of the present invention, is typically viewed from a distance between approximately 406 mm and 457 mm (16 to 18 inches). Taking these factors into account, and through empirical testing, the inventors have determined that the binocular view of a typical six-phase animated image 16 viewed through a 10-degree angled lensed viewing device 18 is preferable over that viewed through a 20-degree angled lensed viewing device 18. This is because, when a lenticular viewing device 18 with lenses of the image decoding panel 36 and image strips of the coded image 16 disposed at 10 degrees is held motionless at arm's length, substantially the same animation phase can be seen simultaneously by both eyes as in the comparison of the images seen by the left and right eyes in Example A. The minor printed cross talk described previously notwithstanding, the subsequent rocking of such a viewing device 18 delivers a convincing animated effect. However, where the image decoding elements and the coded image slices are disposed at a steeper angle of 20 degrees as in Example B and the viewing device 18 is held motionless at arm's length, it is not possible for both eyes to see the same animation phase simultaneously. The undesirable visual confusion described previously will result.

While minor printed crosstalk between printed lines is unavoidable at a 10-degree angular bias, it may be considered preferable over the more disturbing binocular crosstalk created by a 20-degree angular bias. Further, because a 10-degree angle is biased more horizontally than a 20-degree angle, the outputted printed coded image 16 is less susceptible to the kind of “image stretch” previously described, thus retaining a more accurate printed image pitch size consistent with that of the image decoding elements of the image decoding panel 36. The inventors have thus determined that, while other angular biases may certainly be employed in accordance with the invention, optimal results are likely to be obtained with a 10-degree angular bias.

With additional reference to FIG. 17, the computer software retained in electronic memory and operating on the computer processor 32 of the camera 12 can in one illustrative but non-limiting practice of the invention create interlaced images 16 by first recording video at a given resolution, such as of 1280 pixels wide and 960 pixels tall, for a predetermined time period, such as 1 second, at an image capture rate, such as of 32 frames per second. Of the video frames so captured, 32 in this example, the system 10 can then automatically select a plurality of frames to be interlaced and used as the “animation sequence” for the coded image 16. For instance, six origin images OI can be selected in one currently preferred embodiment with the system 10 selecting six equally-spaced frames from the total number of captured frames from the start of the video to the end, such as in the following non-limiting order: frame 1, frame 6, frame 12, frame 18, frame 24, frame 30. This selection process can be altered in the software to offer additional options as discussed further below.

The system 10 then automatically creates the interlaced, coded image 16 electronically as a composite image constructed from interleaving the six captured and selected frames. To prepare the frames for interlacing, the system 10 first temporarily enlarges the selected frames. The resizing process may be dependent on dimensions specific to the brand and model of the thermal printer 14 employed. For example, using one 200-dpi printer, the system 10 might temporarily enlarge each of the six frames to measure 3615 pixels wide and 2710 pixels tall using the nearest neighbor resampling method at a resolution of 2406.4 pixels per inch. If a different brand printer 14 were employed instead that was capable of printing 3M) dpi images, the system 10 might temporarily enlarge the six selected frames to measure 4079 pixels wide and 3058 pixels tall using the nearest neighbor resampling method also at a resolution of 2406.4 pixels per inch.

The system 10 then rotates the enlarged frames in a first rotational direction, such as clockwise or counter-clockwise, by 10 degrees and electronically interlaces the selected frames. To interlace the selected frames, the computer processor 32 and the software of the camera 12 slice each selected original image OI frame into horizontal segments, each of a height of six pixels in this example, to produce sliced images SI. Then, the system 10 takes the first segment from the first sliced image SI frame and places it as the first segment of the interlaced image 16. The system 10 then takes the second segment from the second sliced image SI frame and places it as the second segment of the interlaced image 16. This process is repeated for each selected sliced image SI frame.

After adding the sixth segment of the sixth sliced image SI frame to the interlaced image, the system 10 can go back to the first sliced image SI frame and repeat the interlacing process, this time using the seventh segment of the first sliced image SI frame as the seventh segment of the new interlaced image. This pattern is continued until all segments in the interlaced image 16 are filled. The system 10 then rotates the interlaced image 16 by 10 degrees in a second rotational direction, whether counter-clockwise or clockwise, opposite the first rotational direction back to its original orientation and resizes, such as to 3005 pixels wide and 2253 pixels tall in this example. Again, these dimensions are designed to produce an optimally-pitched scrambled image 16 for one specific thermal printer 14 and may be different for other printers 14. Then, the system 10 applies Floyd-Steinberg or comparable dithering to the interlaced image 16 to produce the final interlaced image 16. The printer 14 can then be automatically or selectively commanded to print out the interlaced image 16.

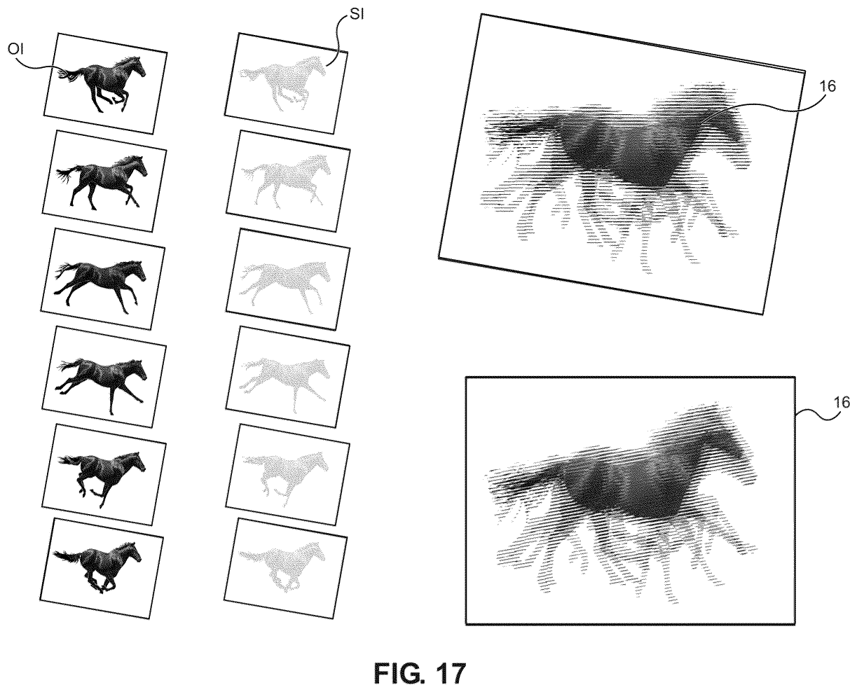

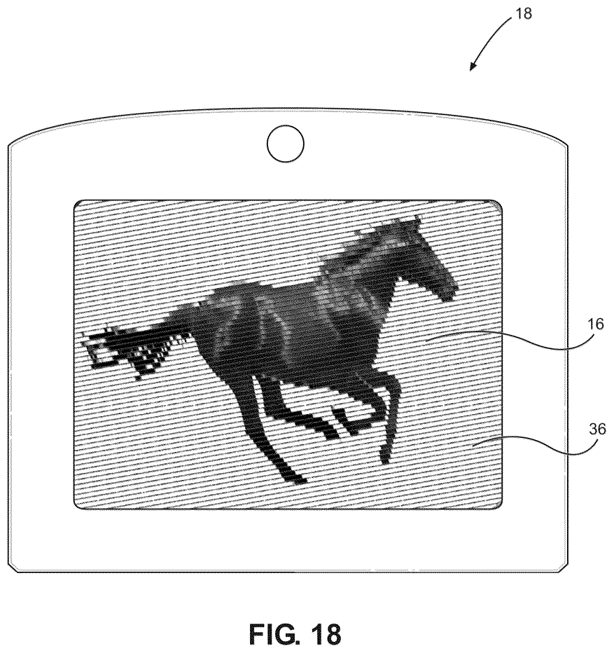

Once the coded image 16 is printed and removed from the camera 12, it is installed in the lenticular viewing device 18 as in FIG. 18. For an optimal animation effect to occur in the viewing device 18, the image slices of the coded image 16, which have been sized, or pitched, by the system 10 to match the pitch of the image decoding elements of the image decoding panel 36 of the viewing device 18, must also be X/Y oriented to be exactly parallel to and thus in precise registration with the image decoding elements. Where the printed coded image 16 is printed crookedly on the paper or other substrate as in Examples A and B, proper animation will be prevented. However, where the printed coded image 16 is printed square to the paper substrate as in Example C, clear animation can be achieved.

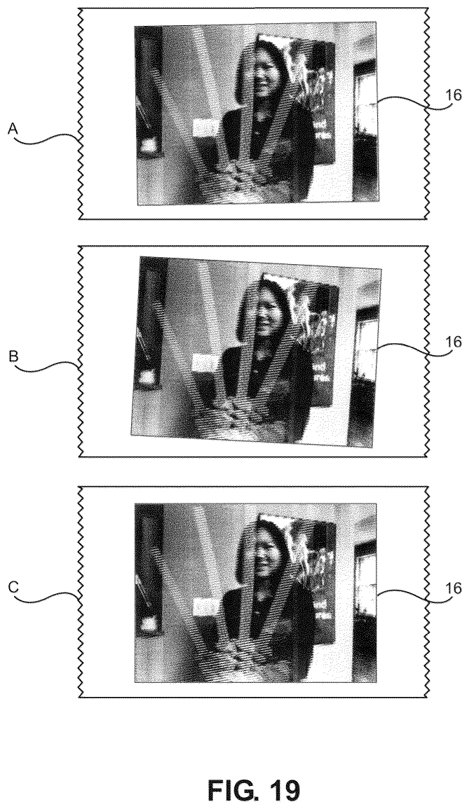

Because the printed coded image 16 must first be removed from the camera printer 14 then manually installed into the lenticular viewing device 18 by the user, specific mechanical and software innovations can be applied to the camera's printer 14 and to the lenticular viewing device 18 to ensure that accurate registration can be achieved without the need for painstaking manual adjustment of the coded image 16 to align with the viewing window of the viewing device 18. First, during printing, the system 10 maintains the coded image 16 to be printed, which may be referred to as the photo proper, as square as possible to the paper that it is printed upon with the top and bottom borders of the photo proper printed exactly parallel to the upper and lower edges of the paper. Additionally, the system software can command the printer 14 to add a minimum border, in this case at least a % inch blank border, at the beginning and end of or prior to and after each printed photo proper of the coded image 16 as shown in FIG. 19.

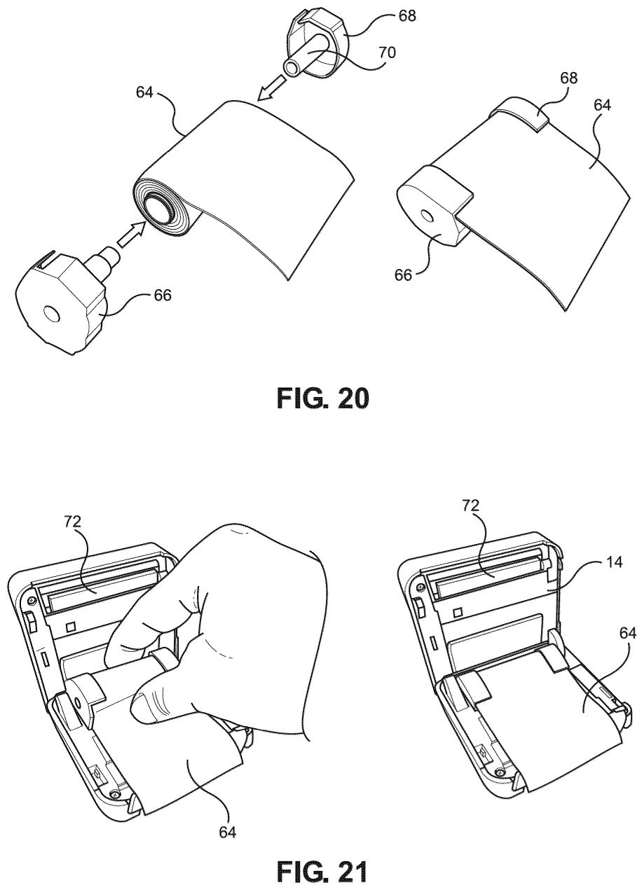

To further ensure the photo proper will be printed exactly in line with the paper it is printed upon, any unwanted play of the roll 64 of paper substrate within the body of the printer 14 must be minimized. In this example, that is done by fitting the paper roll 64 into a holder with end caps 66 and 68 connected by an axle 70 running through the center of the paper roll 64 as in FIGS. 20 and 21. Each end cap 66 and 68 has a guide surface disposed outboard of the respective edge of the paper roll 64 in close proximity thereto and an overlying guide portion that is positioned to overly the respective edge portion of the paper roll 64. So constructed, the end caps 66 and 68 and axle 70 keep the paper roll 64 held snugly within the printer chamber of the printer 14 and in relation to the stationary printer head 72 while keeping the paper roll 64 squarely oriented as the paper substrate unrolls during printing.

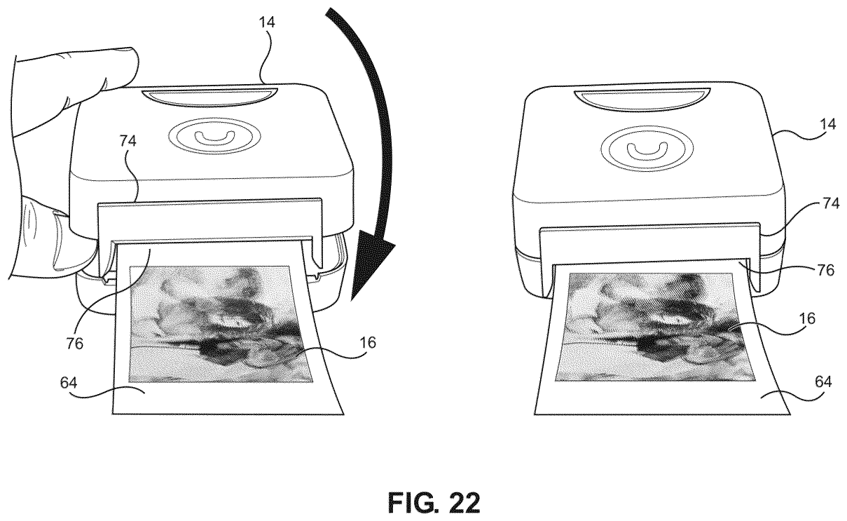

Looking to FIG. 22, to further help square the printing of the photo proper of the coded image 16 on the paper roll 64, an exit guide 74 tailored to the exact width as the thermal paper being used, 56 mm wide in one example, is fixed at the exit mouth 76 of the printer 14. The paper exit guide 74 not only helps to ensure that the paper of the paper roll 64 will retain its straight orientation as it exits the printer 14 but it also serves to prevent the paper roll 64 remaining within the printer 14 from being made crooked when the portion outside the printer 14, now including the printed coded image 16, is torn from the exit mouth 76 of the printer. In this example, the exit guide 64 has a main body portion that spans across the exit mouth 76 of the printer 14 and first and second legs that extend from the body portion to sit astride the edges of the exit mouth 76 of the printer 14 to guide the edges of the paper roll 64 as it exits through the exit mouth 76.

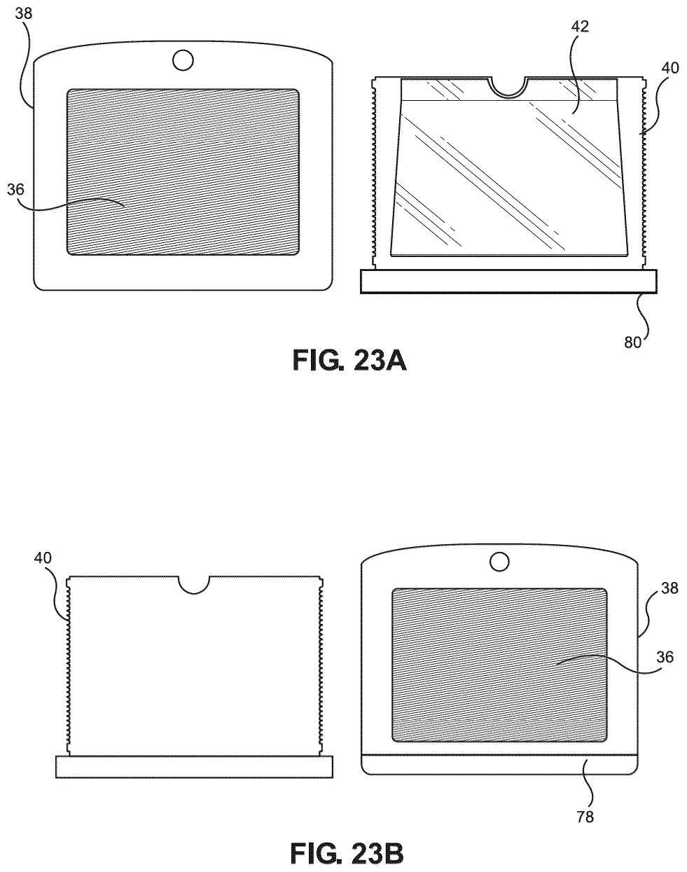

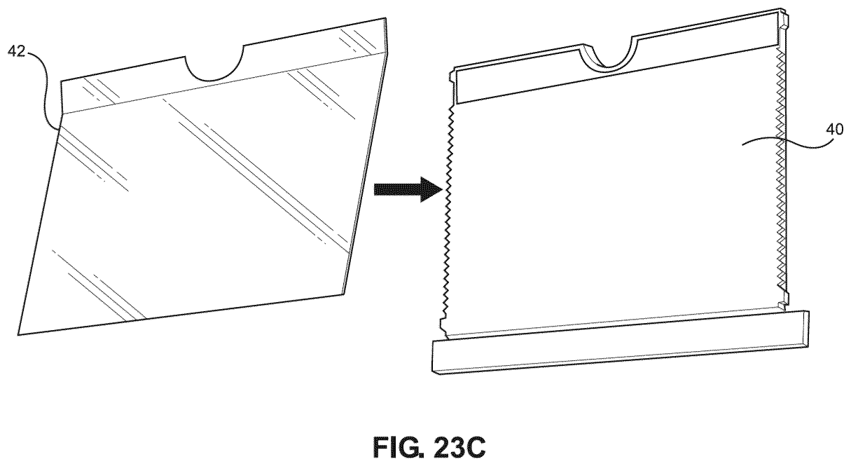

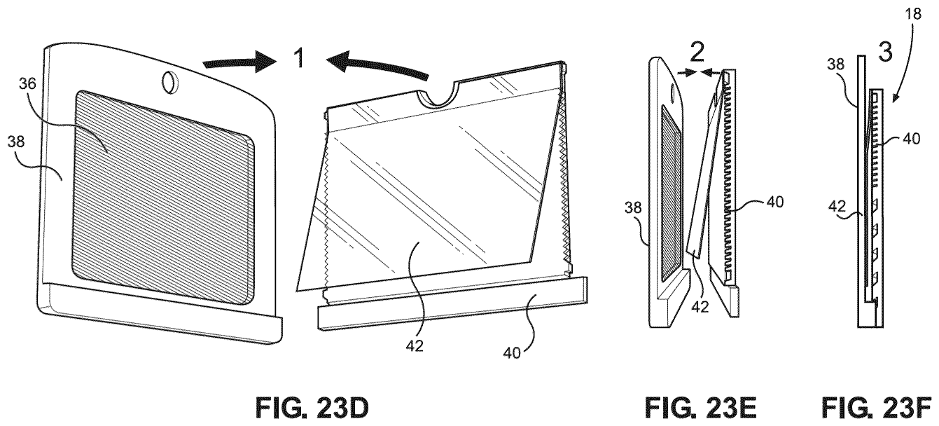

There are multiple possible designs for viewing devices 18 according to the present invention. Preferred designs may be based on, for instance, cost of manufacture and the ability to pass performance requirements. With reference to FIGS. 23A through 23F, one less-costly design for the viewing device 18 can be understood. There, the viewing device 18 is assembled from just three parts. The first part is a front structure 38 comprising a frame and the lenticular image decoding panel 36, which can be molded as one piece. The image decoding panel 36 acts as a viewing window within the front structure 38 and the viewing device 18 in general. The second part is a pressure plate 42, which can be formed as a creased rectangular panel of thin but resilient plastic, such as mylar or polyester. The third part is a rear structure 40, which can have serrated edges at each lateral edge thereof. The pressure plate 42 is adhered to the interior face of the rear structure 40 adjacent to the upper edge thereof.

As best seen perhaps in FIG. 23D, the front structure 38 has a support shelf or rail 78 that protrudes therefrom along the lower edge thereof, and the rear structure 40 has a receiving channel 80 that traverses along the lower edge thereof for receiving a distal portion of the support rail 78 of the front structure 38. The front and rear structures 38 and 40 are thus maintained in a facing relationship with the pressure plate 42 disposed therebetween. A proximal portion of the support rail 78 is disposed to span between the front and rear structures 38 and 40 to act as a rail to support the edge of the coded image 16. When the coded image 16 is disposed atop the support rail 78, accurate X/Y registration of the interlaced slices of the coded image 16 with the image decoding elements of the image decoding panel 36 of the front structure 38 is ensured.

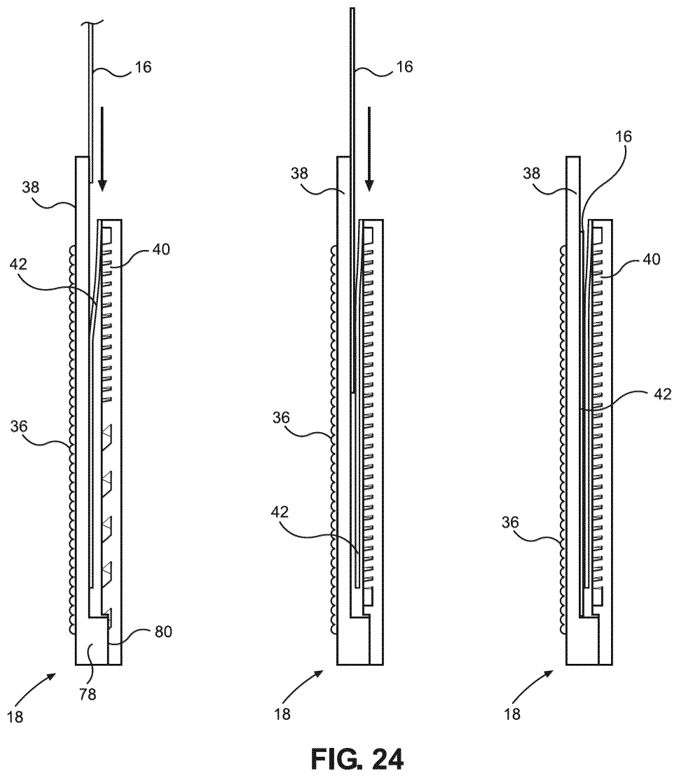

Moreover, as is illustrated in FIG. 24, the crease in the pressure plate 42 causes the pressure plate 42 to lift and how outwardly from the rear structure 40 and toward the front structure 38. This outward bowing operates to press the face of the coded image 16, when inserted, firmly against the inner face of the image decoding panel 36 and thus at the correct focal distance from the lenticular lenses of the image decoding panel 36.

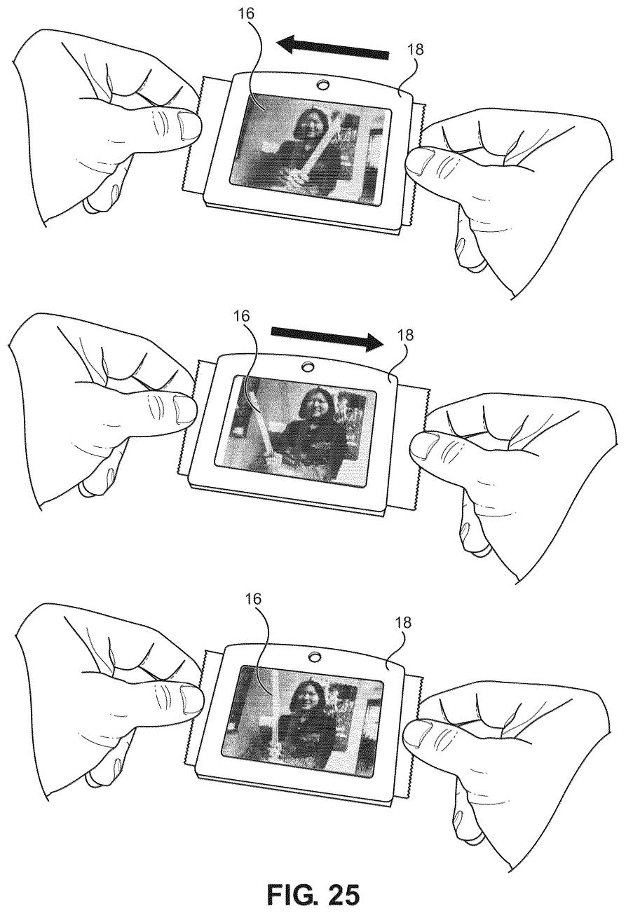

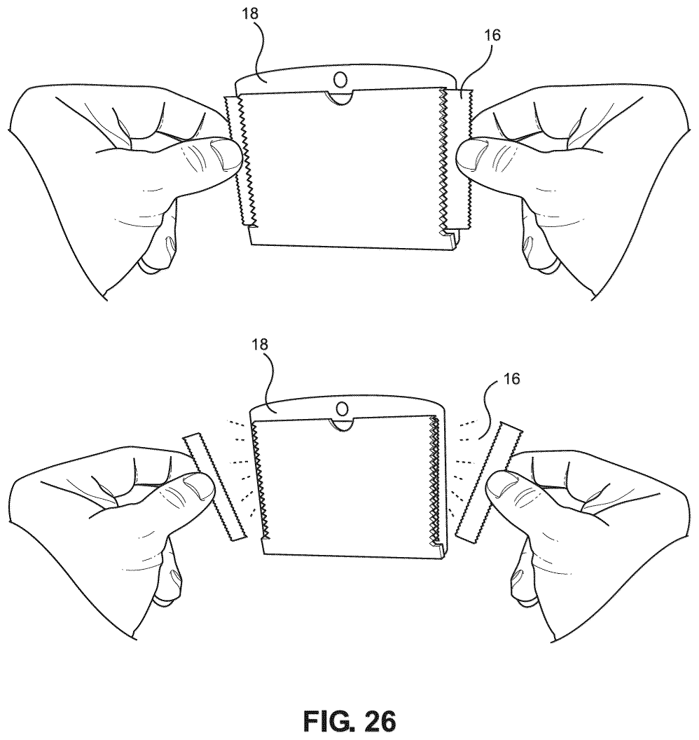

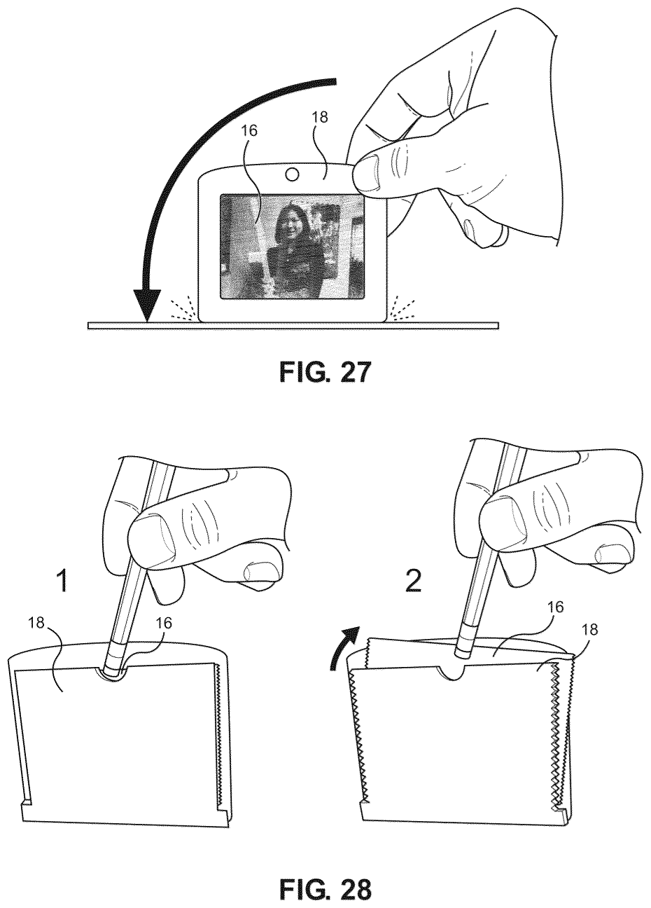

As is depicted in FIG. 25, once the coded image 16 is seated in the viewing device 18 between the front and rear structures 38 and 40 and with the edge thereof in contact with the support rail 78, the user can grasp the protruding ends of the coded image 16 and slide it left or right to center the coded image 16 in relation to the image decoding panel 36. As shown in FIG. 26, once the coded image 16 is satisfactorily centered, the protruding edges thereof can be tom away by use of the serrated edges of the rear structure 40. If the coded image 16 moves out of alignment, such as by no longer being flush with the support rail 78, during removal of the edges thereof, it can be returned to alignment, such as by gently tapping the bottom edge of the viewing device 18 on a surface as shown in FIG. 27.

When desired, the coded image 16 can be removed from the viewing device 18. Even where the edges of the coded image 16 have been removed as described above, the coded image 16 can be accessed, possibly through an aperture or cutout in the viewing device 18, so that it can be slid out of place between the front and rear structures 38 and 40. By way of example and not limitation, it has been found that the coded image 16 can be slid out of place within the viewing device 18 by lightly pressing the end of a pencil's eraser against the small exposed portion of the coded image 16 from behind and sliding it up and out as shown in FIG. 28.

The viewing device 18 so described is exceedingly efficient in structure. As a result, it can be manufactured and distributed at relatively low cost. The efficiency of the viewing device 18 can make it an affordable option, such as to consumers who may wish to distribute viewing devices 18 with freshly-created animations to friends or associates during social, business, and other events and the like. However, in some jurisdictions where plastic components are required to be of at least a certain thickness, it is recognized that the incorporation of a thin pressure plate 42 of clear acetate or polyester film, for instance, could create an issue with toy-testing requirements.

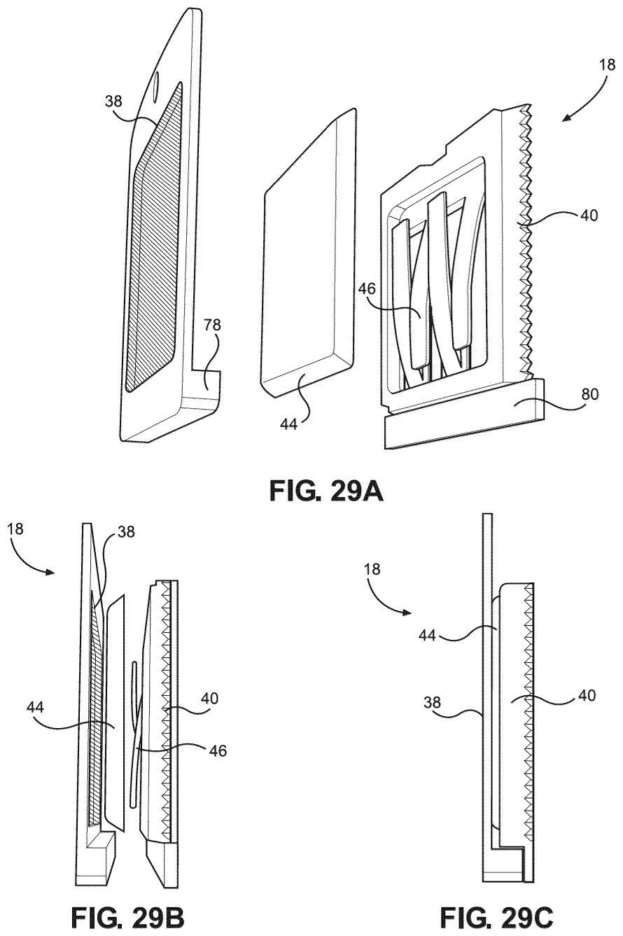

An alternative viewing device 18 that is more likely to pass such test requirements but that may involve higher manufacturing costs is shown in FIGS. 29A through 29C. There, the viewing device 18 again incorporates a front structure 38 and a rear structure 40. Here, however, the coded image 16 is pressed into contact with the inner surface of the front structure 38 by a substantially rigid pressure plate 44 that is in turn resiliently pressed toward the front structure 38 by a plurality of resilient leaf spring members 46 retained by the rear structure 40. The leaf spring members 46 are of effective and acceptable thickness to pass inspection requirements and can be separately or integrally formed with the remainder of the rear structure 40. The front structure 38 again has a support rail 78 traversing the lower edge thereof, and the rear structure 40 has a receiving channel 80 traversing the lower edge thereof for receiving the support rail 78. When the front and rear structures 38 and 40 and the leaf spring members 46 are assembled, the surface of the pressure plate 44 tends to press gently but firmly against the inner surface of the image decoding panel 36 of the front structure 38 by the force of the leaf spring members 46. As best seen perhaps in FIG. 29A, the pressure plate 44 is retained in position by a raised peripheral border of the rear structure 40. With the viewing device 18 of FIGS. 29A through 29C assembled, printed coded images 16 can be inserted, positioned, animated, and removed and replaced as described previously.

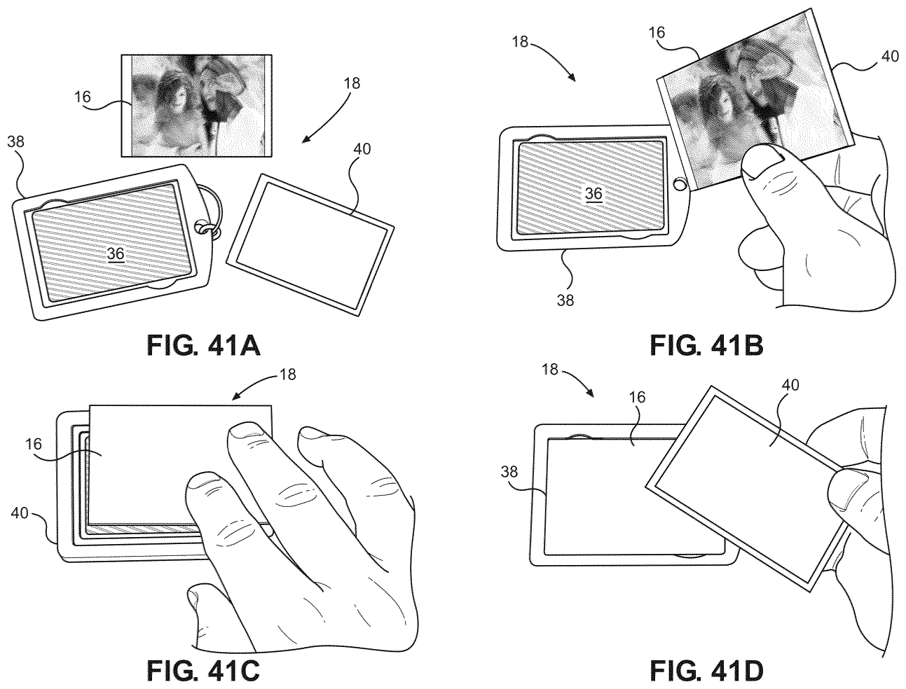

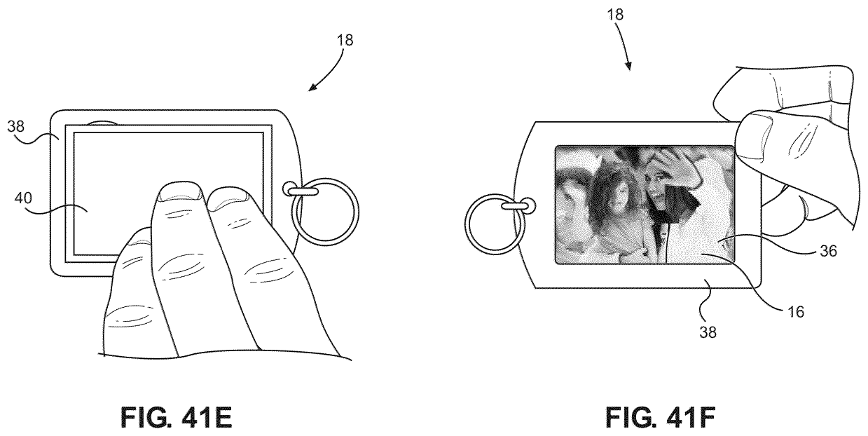

An alternative embodiment of the viewing device 18 is shown in FIGS. 41A through 41F where the viewing device 18 is adapted to retain and display animating interlaced images 16, including images 16 comprising color photo-chemical instant prints, dye-sublimation instant prints, or other prints. In the depicted embodiment, a front structure 38 is again provided with an image decoding panel 36, such as a lenticular sheet or a sheet with spaced decoding shutter elements, incorporated therein. The front structure 38 has a cavity in the rear surface thereof, and a rear structure 40 comprises a rear panel 40 sized to be matingly received into the cavity in the rear surface of the front structure 38, such as in a snap-fit or other relationship. The rear panel 40 is sized and shaped in correspondence to the size and shape of the cavity in the rear surface of the front structure 38. The print of the interlaced image 16, the cavity in the front structure 40, and the rear panel 40 are sized and shaped in mutual correspondence to permit the interlaced image 16 to be snugly received and retained within the cavity in the rear surface of the front structure 40 and between the front structure and the rear panel 40 without excessive play or bowing of the print of the interlaced image 16. The viewing device 18 can additionally include a compressible layer of, for instance, foam, velveteen, or some other resiliently compressible material, for being interposed between the rear panel 40 and the interlaced image 16. In certain embodiments, the compressible layer can be affixed, such as by lamination, to the surface of the rear panel 40.

Under the foregoing construction, the viewing device 18 and the interlaced image 16 can be assembled as depicted in the progressive illustrations of FIGS. 41A through 41F. The interlaced image 16 can be inserted face down into the cavity in the rear surface of the front structure 30 thereby to be in a facing relationship with the image decoding panel 36 of the front structure 38. Then, the rear panel 40 can be snapped into place within the cavity in the rear surface of the front structure 30 overlying the interlaced image 16. With that, the interlaced image 16 is maintained in facing contact with the image decoding panel 36 to permit animation of the interlaced image 16 as described herein, potentially with the layer of compressible material further ensuring that the interlaced image 16 is pressed into full contact with the image decoding panel 36.

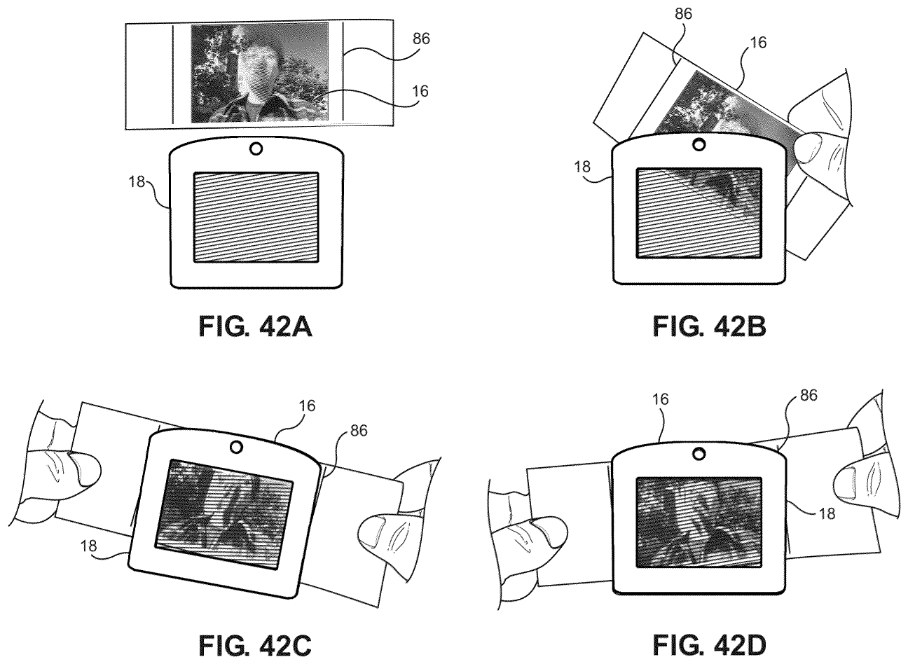

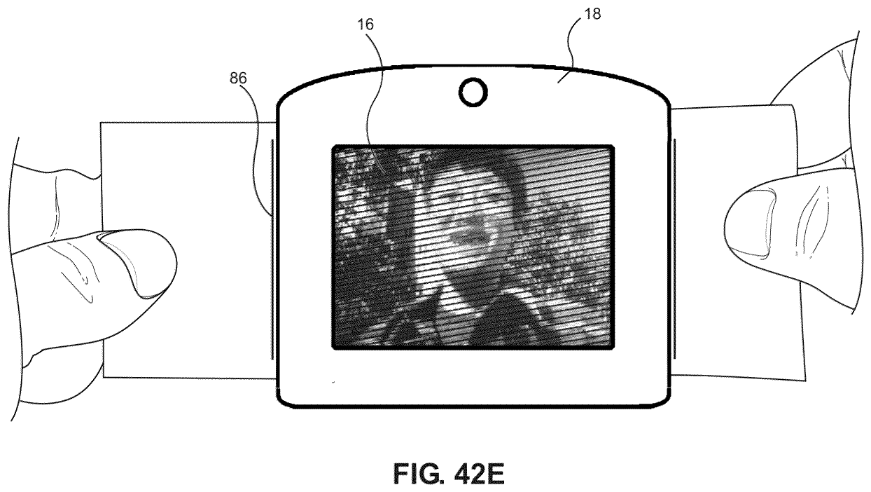

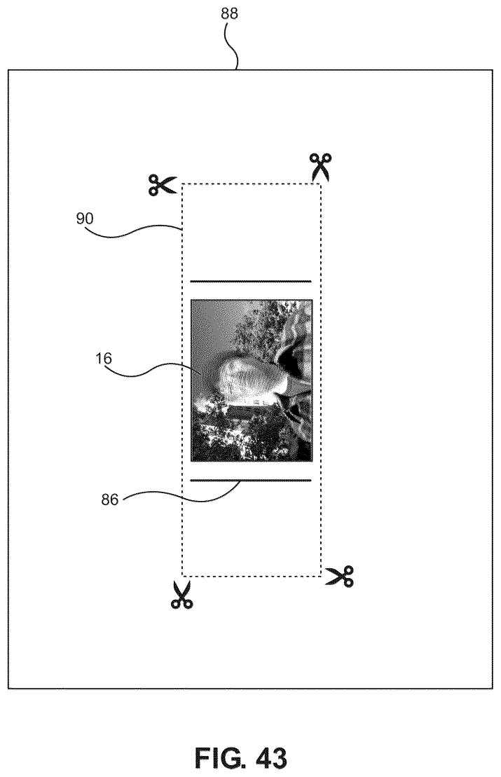

It will be recognized that properly aligning the interlaced, coded image 16 with the image decoding elements of the image decoding panel 36 is critical to proper animation by operation of the viewing device 18. Therefore, additionally or alternatively to the other aligning mechanisms and methods disclosed herein, embodiments of the system 10 are contemplated wherein proper x/y alignment of the interlaced image 16 in relation to the image decoding panel 36 is ensured through a user-adjustable visual method of alignment as depicted in FIGS. 42A through 42E. There, by operation of the computer software and the printer 14, each interlaced image 16 is additionally printed with vertical alignment lines 86 lateral to the printed image 16. The alignment lines 86 are parallel to one another and perpendicular to the upper and lower edges of the substrate of the printed image 16 with the printed image 16 centered therebetween. The alignment lines 86 are calibrated to be spaced in correspondence to the space between the left and right edges of the viewing device 18, such as to match that space exactly. In one example where the viewing device 18 is 90 millimeters wide, therefore, the alignment lines 86 would likewise be spaced 90 millimeters from one another with the interlaced image 16 disposed therebetween.

As in FIGS. 42A through 42E, the interlaced image 16 with the alignment lines 86 disposed outboard thereof can then be inserted into the slot of the viewing device 18. The interlaced image 16 can then be adjusted until the alignment lines 86 are exactly aligned with the left and right edges of the viewing device 18. With that, x/y alignment between the slices of the interlaced image 16 and the image decoding elements of the viewing device 18 is established and confirmed.

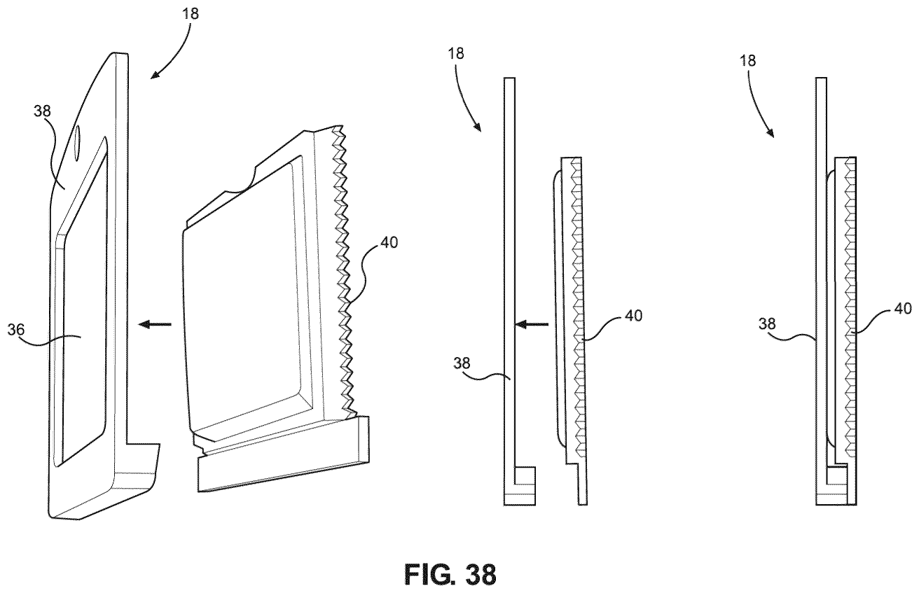

A further embodiment of the viewing device 18 is shown in the progressive assembly views of FIG. 38. The viewing device 18 again relies on a front structure 38 and a rear structure 40, the front structure 38 with a support rail 78 that is matingly received by a channel 80 in the rear structure 40. Here, however, the requirement for a third component of the viewing device 18 is eliminated entirely. Rather than a separate pressure plate, the rear structure 40 itself includes an integral pressure plate portion comprising a central, rectangular portion of the rear structure 40. That pressure plate portion of the rear structure 40 can have rounded edges to facilitate, among other things, a smooth insertion and removal of coded images 16. The portion of the rear structure 40 distal to the receiving channel is adapted to be canted or tilted toward the front structure 38 prior to assembly. When the viewing device 18 is fully assembled with the front and rear structures 38 and 40 being are permanently joined, the pressure plate structure and the remainder of the portion of the rear structure 40 distal to the receiving channel tends to be pressed into an orientation parallel to the image decoding panel 36 of the font structure 38 thereby creating full face-to-face pressure of the pressure plate structure against the inner face of the image decoding panel 36. The spring pressure of the pressure plate structure of the rear structure 40 against the image decoding panel 36 of the front structure 38 is light enough spring to permit easy insertion of the coded image 16 yet sufficient to retain in inserted coded image 16 in place.

The display screen 20 of the camera 12 permits the immediate display of a preview of captured image frames and image sequences and for a review of several digital alternative versions of captured image frames and image sequences before printing. The computer software operating on the camera 12 can additionally display on the display screen 20 a simulation of the captured motion by displaying selected frames of an image sequence as a short video or as a repeatedly cycling animated GIF. However, a more accurate and thus preferable preview method features the image decoding panel 24, such as a lenticular plate, affixed to overlie the display screen 20. Again, the image decoding panel 24 can be fixed in place or removable and replaceable. In such embodiments, the camera software displays a digital version of the interlaced image 16 beneath the image decoding panel 24. The image decoding panel 24 naturally decodes the interlaced image 16, and a user can rock the camera 12 toward and away from themselves to see the animation on the display screen 20 in much the same manner as they would view the printed interlaced image 16 in the viewing device 18. This preview method simulates how the printed coded image 16 will look and perform once installed in the viewing device 18 and is a more interactive and fun experience for the user as compared to watching a self-animating digital screen.

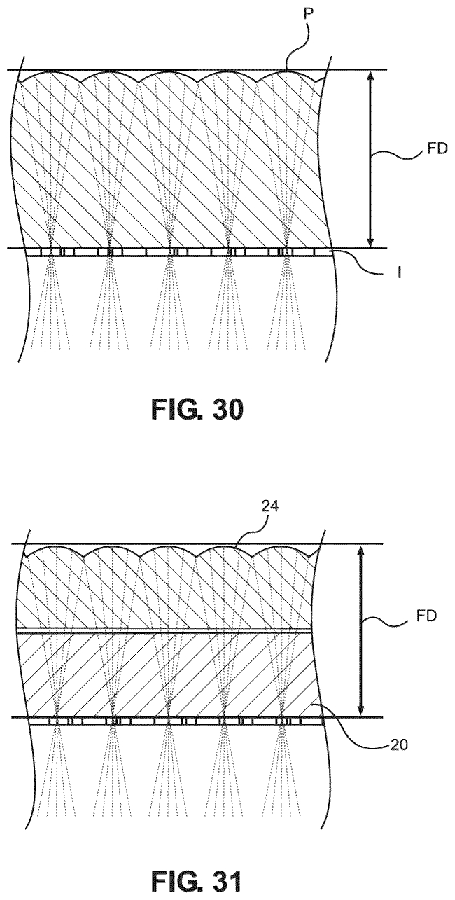

To make the display screen 20 and image decoding panel 24 cooperate to perform optimally, the inventors appreciated that a typical lenticular plate cannot simply be affixed to the display screen 20 because the lenses of a typical lenticular plate are designed to focus exactly upon the back wall of the plate. For an animation to be viewed, the face of a separate, printed interlaced image or photo must be firmly pressed up against that rear surface, such as by lamination, as in FIG. 30 where a typical 40 lpi lenticular plate P with lenses having a 1/10″ ball arc is depicted. To perform optimally, the lenticular plate P in such a structure must measure exactly 2 mm from the top arc of any one of the lenses to the back of the plate P thereby matching the focal distance FD of the lenses. If such a typical lenticular plate were laminated directly to the surface of a typical display screen displaying a correctly-pitched interlaced image I, it would not focus on that image because the display screen itself is covered by a protective surface of thin glass or plastic, usually 1 mm thick. Thus, if a typical lenticular plate P were placed over it, the distance between the lenses and the interlaced image would be 3 mm instead of the desired 2 mm, far beyond the focusing distance of the lenticular lenses.

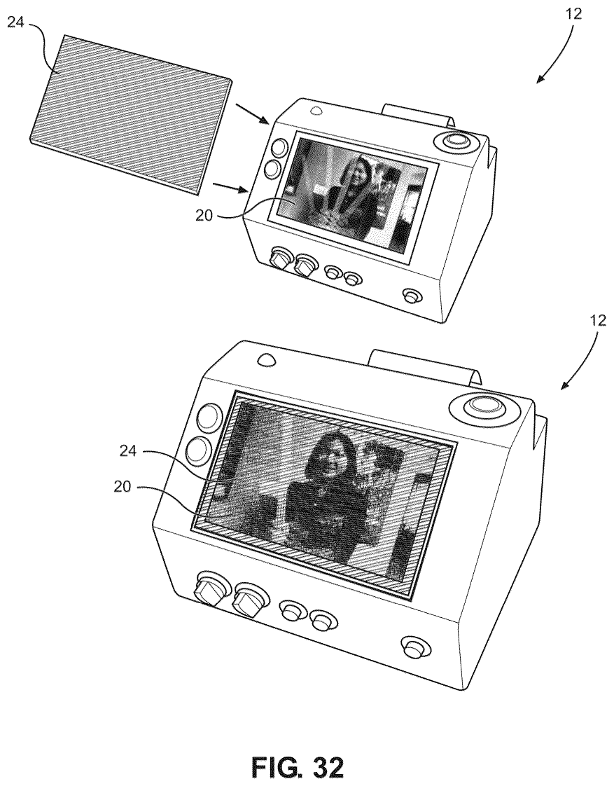

Looking to FIGS. 31 and 32, one solution according to the invention is to custom-manufacture a special, atypical lenticular plate image decoding panel 24 that is only 1 mm thick and to affix that directly to the surface of the 1 mm thick display screen 20. With that, the desired 2 mm focal distance FD will be achieved and the coded image 16 will animate clearly. Other variations could be accommodated. For instance, if the protective surface of the display screen 20 were instead 0.5 mm thick, the custom-made lenticular plate image decoding panel 24 could be manufactured at a 1.5 mm thickness.

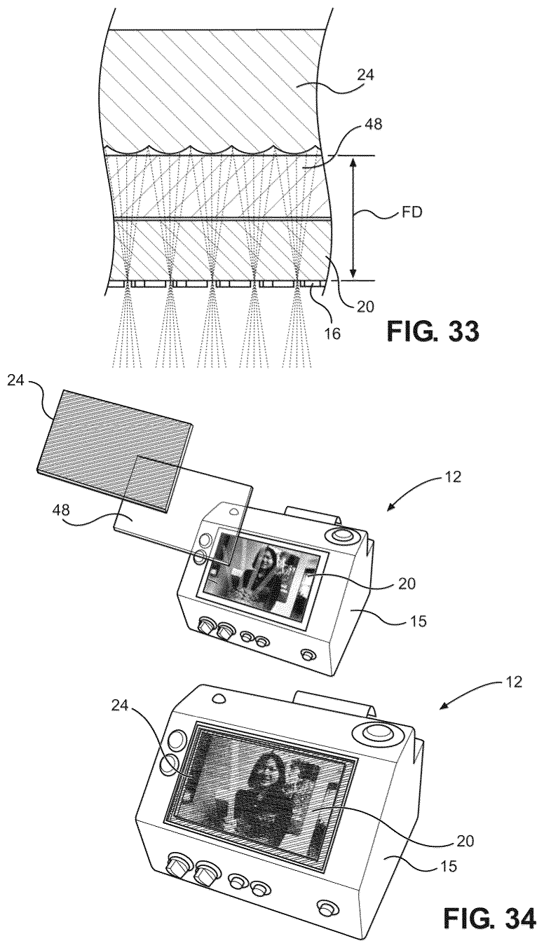

Another solution, as is shown in FIGS. 33 and 34, permits the use of a typical 2 mm thick lenticular plate image decoding panel 24 that is inverted to have the lensed surface facing the display screen 20 rather than outwardly. An additional, 1 mm thick spacing panel 48 of transparent material, such as glass or plastic, is sandwiched between the image decoding panel 24 and the display screen 20. The inverted peaks of the lenses of the image decoding panel 24 will then be placed at the desired 2 mm distance from the coded image 16 provided by the display screen 20.

During assembly of the display device 18, care must be taken not to adhere the lensed face of the lenticular plate image decoding panel 24 directly to the spacing panel 48 to avoid compromising the optics of the lenses. Instead, as illustrated, a thin bead of adhesive or double-sided tape may be applied just inside the perimeter of the lenticular plate image decoding panel 24 thus effectively bonding to the spacing panel 48 while leaving the central lensed area free of adhesive or other optical contaminants. So joined, the image decoding panel 24 and the spacing panel 48 can be retained relative to the display screen, potentially by being affixed by lamination or otherwise.

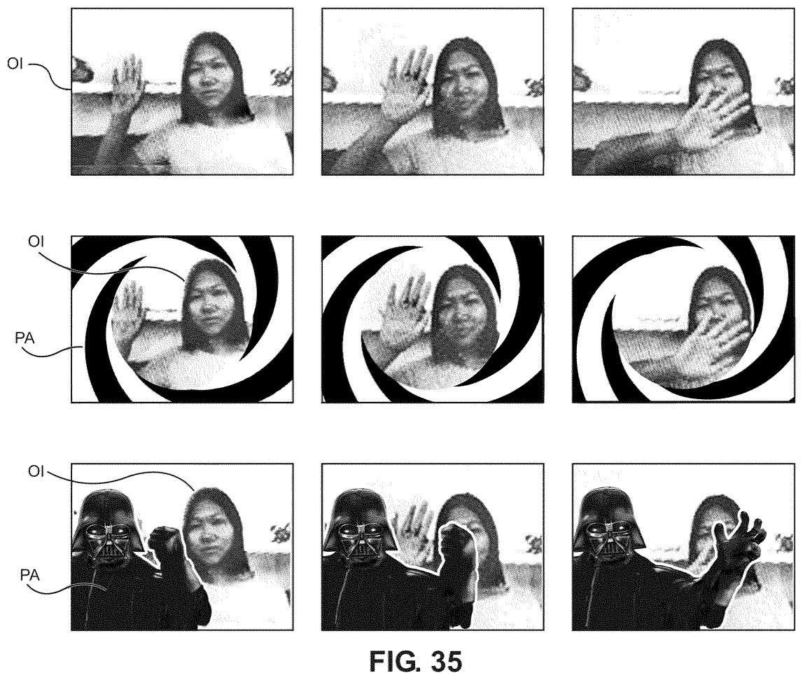

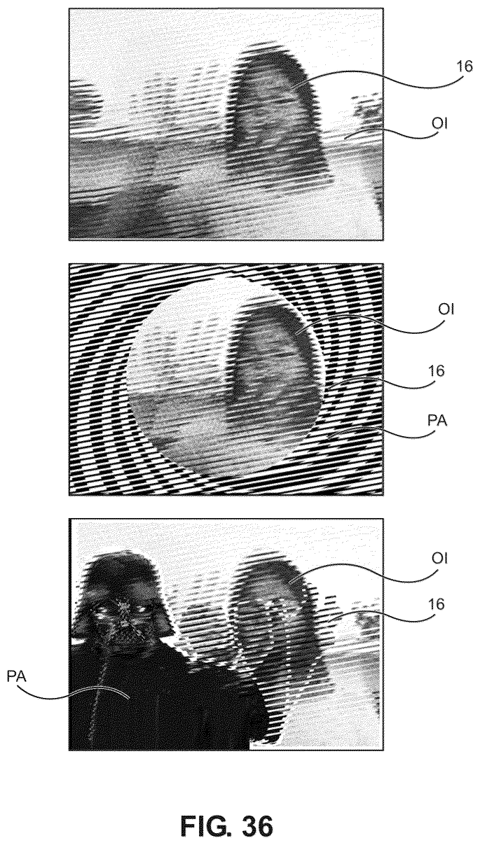

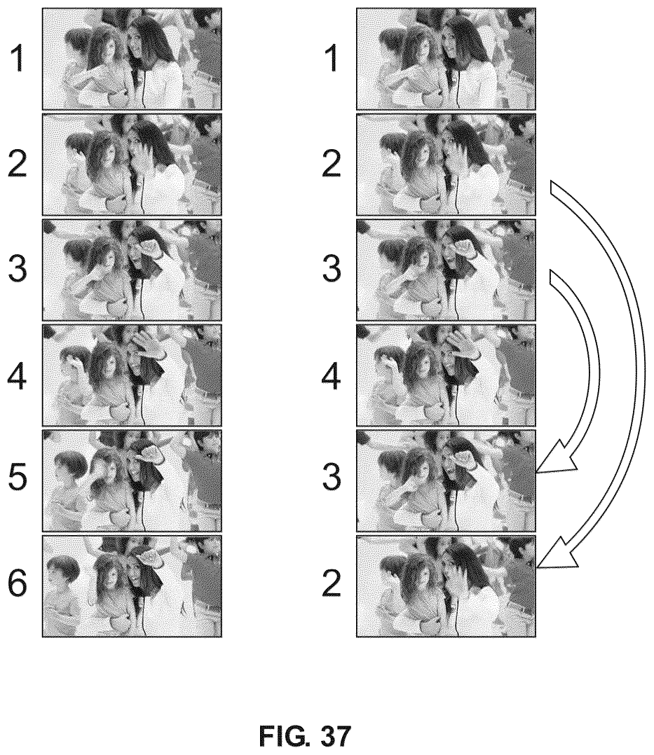

As disclosed herein, animation of the live subject captured by the camera 12 can be merged with, or matted into, a pre-animated, pre-interlaced scene already stored in the electronic memory of the camera 12. Such merging can be carried out using electronic photo matting methods as would be known to one skilled in the art after reviewing the present disclosure. A user can, for example, select from a plurality of pre-animated scenes or combinations thereof. PA. Pre-animated scenes PA can be viewed on the display screen 20 in combination with or perhaps separately from the captured original images OI after the images OI are captured. In other practices of the invention, the user could frame their live subject in a predetermined reveal area of a pre-animated scene using PA that pre-animated scene PA as a guide as is depicted in FIG. 35. The shutter button 26 and the indicator light 28 can be used to trigger the capture of images and to cue the subject of that image capture. By operation of the computer software running on the computer processor 32, the camera 12 can then automatically or selectively produce a composite coded image 16 of the pre-animated scene PA and the captured original images OI as in FIG. 36.

It is also possible to employ customizable features within the camera 12 to allow the user to determine video capture length and to isolate specific segments of captured videos to be processed. For instance, where a one-second, 30-frame video scene is captured, a user could use an input on the camera 12, such as one of the buttons or dials 50 through 60 or the electronic user interface on the display screen 20, to peruse a selection of possible optional image animation sequences derived from that video before deciding which sequence or sequences to print. Each of these image sequences would appear as a series of pre-interlaced images on the display screen 20 with the user rocking the camera 12 to produce animation.

For example, immediately after action is captured, the computer software of the camera 12 might automatically create seven optional six-phase interlaced images 16. One optional image could be formed from an image sequence of six equally-spaced frames chosen from the start to the end of the video, such as frame 1, frame 6, frame 12, frame 18, frame 24, and frame 30. In another option, the image sequence can comprise every second frame from the middle section of the video, such as frames 10, 12, 14, 16, 18, and 20, for processing while a third option might entail processing an image sequence comprising every third frame from the middle section of the video, such as frames 8, 11, 14, 17, 20, and 23. In a fourth image sequence option, every second frame from the first half of the video, such as frames 1, 3, 5, 7, 9, and 11 might be processed, and a fifth option for an image sequence might involve processing every third frame from the first half of the video, such as frames 1, 4, 7, 10, 13, and 16. Still further options might involve processing image sequences comprising every second frame from the last half of the video, such as frames 20, 22, 24, 26, 28, and 30 or processing an image sequence comprising every third frame from the last half of the video, such as frames 12, 15, 18, 21, 24, 27, and 30. A user could toggle forward and backward through the above image sequences and potentially further or different options to visually compare them to one another before deciding which to print.

In this regard, it is notable that, through empirical testing, the inventors have determined that, in most cases, the last two thirds of a one-second video captured in the manner described will normally contain the preferred action sequences from which these image sequence algorithms can be derived. Also according to practices of the system 10, the image processing computer software operating on the camera 12 can be employed, whether by manual actuation or automatically, to identify and select through software operation a segment of the video with the greatest or most significant action from which image frames are selected for image slicing and interlacing as an image sequence to produce a coded, interlaced image 16 as taught herein.

A simpler practice of the invention, which has been field tested with promising results by the inventors, is to provide a limited plurality, such as three, post-capture options of image selection from which to choose. For instance, a first option for possible selection can be equally spaced frames from the first two-thirds of the plurality of captured image frames, such as the 32 captured image frames in the non-limiting example provided, so that frames 1, 5, 9, 13, 17, and 21 would be automatically selected as an image sequence for processing into the coded image 16. A second option could produce an automatic selection of equally spaced frames from the middle two-thirds of the captured image frames so that frames 6, 10, 14, 18, 22, and 26 would be automatically selected as an image sequence for processing. A third option could produce an automatic selection of equally spaced frames from the last two-thirds of the captured image frames such that frames 12, 16, 20, 24, 28, and 32 would be automatically selected as an image sequence for processing. Assuming that the heart of the subject's captured action is somewhere within the body of the original captured image frames, one of these three selections of image sequences is likely to yield a pleasing coded image 16.

In certain instances, it may be desirable to smooth out the animation effect produced by the camera 12 and the coded image 16. The computer software operating on the camera 12 can allow the user to apply an automatic looping algorithm to each provided image selection option. Such a looping algorithm could, by way of non-limiting example, automatically select the first four phases of a selected option, such as phases 1, 2, 3, and 4 in consecutive order, and then add duplicates of phases, such as phases 3 and 2 in that order, to create and complete a final image sequence, which in this example provides six phases. By circling back to its start point, this animation algorithm eliminates the animated display of finite subject actions which, due to the unavoidable repetition of animation cycles as the viewing device 18 is rocked in one direction, might otherwise display actions that appear to jerk back to a starting position in a disorienting and visually upsetting manner before repeating themselves.

It should be understood that the camera 12 and the coded images 16 are not limited to black-and-white thermal printed photos. A full color mini-printer 14 could be employed within the camera 12. By way of example and not limitation, a printer 14 could be employed that produces dye sublimation printed coded images 16 or coded images 16 embedded with heat-activated color crystals activated by a heated printing head. Moreover, while lenticular panels 24 and 36 arc often shown and described herein, it will again be understood that either or both image decoding panels 24 and 36 could alternatively comprise barrier grid image decoding panels 24 or 36 within the scope of the invention.

As described above, previewing coded images 16 on the display screen 20 through an image-decoding panel 24 can be a more interactive and enjoyable experience as compared to watching a self-animating digital rendering that presents continuously cycling, multi-frame animations derived from the frame-capture algorithms from captured video. It is, of course, nonetheless recognized that a self-animating display screen 20 can be substituted and the need for a lenticular overlay eliminated. Such a self-animating screen 20 permits an acceptable method of previewing and simulating for the user how the captured action of the image sequence will perform once the coded image 16 is printed and installed in the lenticular viewer 18. This is within the scope of the invention except as expressly excluded by the claims.

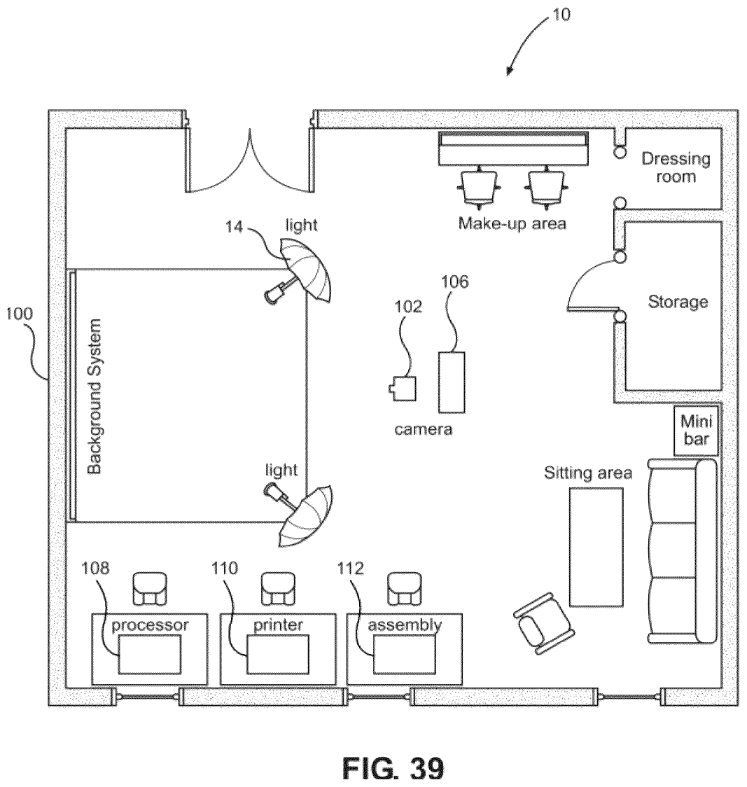

Indeed, there are manifestations of the invention where a self-animating screen preview might be considered preferable to a lenticular-covered display screen 24. For example, an alternative embodiment of the invention could be reimagined as an event venue, such as an impromptu photo booth or kiosk at a wedding, birthday celebration, or in a public mall. Such a venue might be as small and user-operated as a traditional photo booth. In a larger format, such as is shown in FIG. 39, such a system 10 for custom coded image creation and the viewing of animations derived therefrom might house a professionally-lit stage 100 for users to perform under professional lighting 104 before a stand-alone digital camera 102 to be operated by a professional. The camera 102 could be mounted directly over or in direct proximity to a monitor 106 so the subjects can view and rehearse their performance.

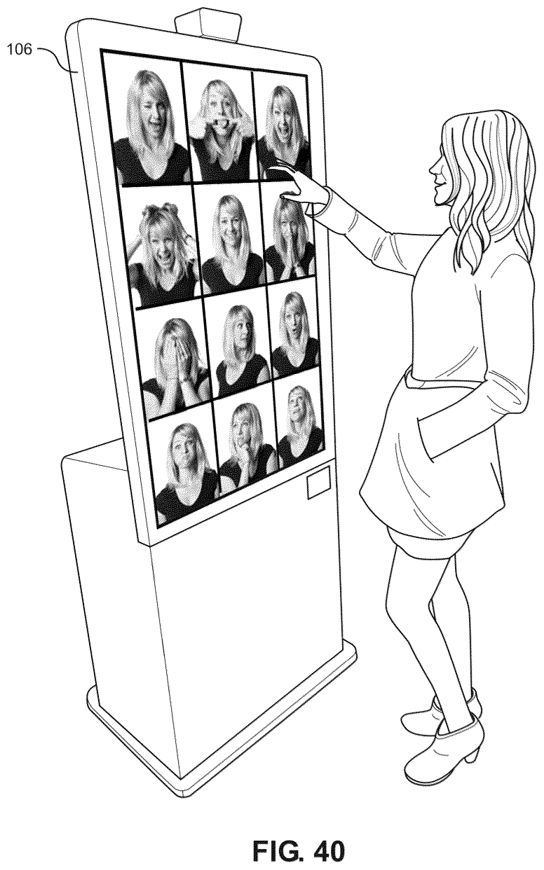

After the short video is captured by the camera 102, the monitor 106 could instantly display multiple animations derived from that video side by side on the monitor 106 as in FIG. 40. Then, simply by touching the display screen of the monitor 106, the user can choose which particular animation they want printed out and installed in the viewing device 18 as a coded image 16. Multiple prints of the same coded image 16 could then be installed in multiple viewing devices 18 and distributed among the participants as a keepsake. Further, it should be noted that in such a venue embodiment of the system 10, the camera 102, the monitor 106, the digital processor 108, and the printer 110, instead of being combined together in one compact package, may be separate, dedicated components, each electronically connected by wired or wireless connections. Such embodiments can, for instance, facilitate the use of a high-end camera 102 to enable improved captured images, a high-end image processor 108 to improve processing of the algorithms derived from the captured images, and dedicated printers 110 to enable larger and higher resolution coded images 16. Such embodiments can also provide, where necessary, for a professional assembly station 112.

It should also be considered to be within the scope of the disclosed invention to process and produce coded, interlaced images 16 from separately created video files, that is, from files not directly created by use of the cameras 12 or 102 shown and described hereinabove. For instance, it would be possible to upload a video shot on a user's separate video apparatus, such as a video camera, a smart phone, or other apparatus, to the software platform of the present system 10. The video so uploaded can then be processed as would a video obtained by use of a dedicated camera 12 or 102 as shown herein. In such practices, the software of the system 10 prompts the user to scroll through the video, such as by use of an analog or digital slider or otherwise, to choose video segments from which the system software is programmed to harvest original images for processing into sliced images and, ultimately, into coded, interlaced images 16. As with coded images 16 obtained through the cameras 12 or 102, the resulting coded images 16 can then be printed and installed into a viewing device 18 according to the present invention.

In a similar vein, it is recognized that, despite the advantageousness of being able to print immediately available, inexpensive coded images 16 by use of the integrated printer 14 of the camera 12 disclosed herein, certain users may additionally or alternatively wish to have color images and images of higher quality than the black and white, thermally printed images 16 produced by contemplated embodiments of the camera 12. Although it is possible and within the scope of the invention except as expressly excluded by the claims to incorporate a high-resolution color printer 14 within the camera 12, it would additionally be possible to transmit interlaced, coded images 16 produced by the camera 12 to a separate printer (not shown), such as a home or office printer.

While the integrated printer 14 of embodiments of the present invention may be adapted to print black and white, thermally printed images 16 to achieve cost and design efficiencies, the camera 12 and the electronic memory retained therein can obtain and retain high-resolution color electronic versions of the interlaced, coded images 16. Those electronic versions can be electronically transferred, whether through a separate computing device or directly, to a home or office color printer. The electronic transfer of the coded images 16 could be carried out by a wired connection, such as a USB or other cable, by a wireless connection, by transfer of an electronic memory device, such as a memory card, or by any other effective mechanism. As is illustrated in FIG. 3, the system 10 is programmed to prepare an electronic file for transfer of such interlaced, coded images 16 for printing on a standard paper sheet 88, such as an 8½×11 inch sheet 88. The transferred electronic file can include, in addition to the coded image 16 itself, guide lines 90 to guide in cutting the coded image 16 from the sheet 88 as well as alignment lines 86 as show and described herein for ensuring proper alignment of the coded image 16 within a viewing device 18. With that, relatively low-cost printing is maintained while high-quality color coded images 16 can be printed and animated according to the present invention.

The capability to transfer electronic versions of the interlaced, coded images 16 to a separate printer directly or through a computing apparatus, such as a home computer, laptop, or smart phone, also presents the possibility of printing larger interlaced, coded images 16 and installing such larger images 16 into larger viewing devices 18 with image decoding panels 26 for animation. For instance, a separate printer could readily print, by way of example and not limitation, 8×10 inch versions of coded images 16 created by the computer software operating on the camera 12. Although such coded images 16 and viewing devices 18 could have image slices and image decoding elements disposed along an angular bias as taught herein, it is recognized that such larger viewing devices 18 may have image decoding elements disposed without an angular bias, such as horizontally. In such cases, the coded images 16 would thus likewise be produced and printed by the computer software without an angular bias. To produce animation, such larger viewing devices 18 might then be rocked back and forth, mounted on a motorized device, moved with a pendulum construction, or otherwise caused to move relative to the viewer.

With certain details and embodiments of the present invention for a system 10 for the creation of custom coded images and the viewing of those coded images as custom animations disclosed, it will be appreciated by one skilled in the art that numerous changes and additions could be made thereto without deviating from the spirit or scope of the present invention. This is particularly true when one bears in mind that the presented preferred embodiments merely exemplify the broader invention revealed herein. Accordingly, it will be clear that those with major features in mind could craft embodiments that incorporate those major features while not incorporating all of the features included in the preferred embodiments.

Therefore, the patent claims that ultimately issue shall define the scope of protection to be afforded to the invention. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

What is claimed as deserving of Letters Patent is:

1. A system for the creation and viewing of custom interlaced, coded image animations, the system comprising:
a camera body;
a camera lens retained by the camera body;
a digital camera unit retained by the camera body for capturing digital images through the camera lens;
electronic memory for receiving digital images captured by the digital camera unit;
image processing computer software retained in the electronic memory;
a computer processor operative to process the digital images captured by the digital camera unit by operation of the image processing computer software;
a shutter actuator retained by the camera body for selectively causing images to be captured by the digital camera unit through the camera lens over a time period;
wherein the image processing computer software and the computer processor are operative to process images captured by the digital camera unit over the time period to establish an image sequence comprising a plurality of images from among the images captured by the digital camera unit over the time period, wherein the image processing computer software and the computer processor are operative to create an interlaced, coded image from the plurality of images of the image sequence, wherein the interlaced, coded image comprises interlaced slices of the plurality of images of the image sequence, and wherein the interlaced, coded image is adapted to be printed to create a printed interlaced, coded image.

2. The system of claim 1, further comprising a printer retained by the camera body wherein the printer is operative to print interlaced, coded images created by the image processing software and the computer processor from image sequences of images captured by the digital camera.

3. The system of claim 2, wherein the printer comprises a thermal printer.

4. The system of claim 1, further comprising a display screen retained by the camera body, wherein the image processing computer software, the computer processor, and the display screen are operative to create and display interlaced, coded images created by the image processing software and the computer processor from image sequences of images captured by the digital camera.

5. The system of claim 4, further comprising an image decoding panel retained atop the display screen for decoding coded images displayed on the display screen.

6. The system of claim 4, wherein the image processing computer software, the computer processor, and the display screen are operative to create and selectively display plural different interlaced, coded images based on image sequences comprising at least some different images or differently ordered images from among the images captured by the digital camera unit over the time period.

7. The system of claim 1, further comprising an indicator light on the camera operative to cue a subject regarding image capture by the digital camera unit.

8. The system of claim 1, further comprising a viewing device for receiving printed interlaced, coded images, wherein the viewing device has an image decoding panel for decoding the printed interlaced, coded images.

9. The system of claim 8, wherein the viewing device comprises a front structure with the image decoding panel and a rear structure, wherein the front structure and the rear structure are adapted to receive printed interlaced, coded image therebetween.

10. The system of claim 9, further comprising a biasing mechanism for biasing printed interlaced, coded images into contact with the image decoding panel of the front structure.

11. The system of claim 10, wherein the viewing device further comprises a support rail disposed to traverse longitudinally between the front and rear structures, wherein the support rail is operative to support and X/Y orient printed interlaced, coded images in relation to the image decoding panel of the viewing device.

12. The system of claim 1, wherein the interlaced, coded image is adapted by the image processing computer software and the computer processor to be printed onto a printing substrate that has first and second parallel edges with the interlaced slices of the plurality of images of the image sequence disposed on an angular bias away from horizontal in relation to the edges of the printing substrate.

13. The system of claim 12, wherein the angular bias is approximately 10 degrees.

14. The system of claim 1, wherein the image sequence comprises approximately six images captured by the digital camera unit.

15. The system of claim 1, further comprising pre-animated, pre-interlaced scenes stored in the electronic memory, wherein the image processing computer software is operative to selectively merge the pre-animated, pre-interlaced scenes with the image sequence captured by the digital camera unit.

16. The system of claim 1, wherein the image processing computer software and the computer processor are operative to create plural different interlaced, coded images based on image sequences comprising at least some different images or differently ordered images from among the images captured by the digital camera unit over the time period.

17. The system of claim 16, wherein the image processing computer software and the computer processor are operative to permit a manual selection of one interlaced, coded image from among the plural different interlaced, coded images for printing to create a printed interlaced, coded image.

18. The system of claim 16, further comprising a display screen retained by the camera body, wherein the image processing computer software, the computer processor, and the display screen are operative to permit a manual selection of one interlaced, coded image from among the plural different interlaced, coded images for display on the display screen.

19. The system of claim 1, wherein the image processing computer software and the computer processor are operative to create an interlaced, coded image from the plurality of images of the image sequence by automatically electronically slicing each of the plurality of images of the image sequence and placing slices of the plurality of images in an interlaced sequence.

20. The system of claim 19, wherein the image processing software and the computer processor are operative to rotate each of the plurality of images of the image sequence by a given angular bias in a first rotational direction prior to electronically slicing each of the plurality of images of the image sequence, then to automatically electronically slice each of the plurality of images of the image sequence and to place slices of the plurality of images in an interlaced sequence, and then to re-rotate the interlaced, coded image so created in a second rotational direction opposite the first rotational direction over the angular bias.

21. The system of claim 19, wherein the image processing computer software and the computer processor are selectively operative to apply an automatic looping algorithm to the plurality of images of the image sequence.

22. A system for the creation and viewing of custom interlaced, coded image animations, the system comprising:
a camera body;
a camera lens retained by the camera body;
a digital camera unit retained by the camera body for capturing digital images through the camera lens;
electronic memory for receiving digital images captured by the digital camera unit;
image processing computer software retained in the electronic memory;
a computer processor operative to process the digital images captured by the digital camera unit by operation of the image processing computer software;
a shutter actuator retained by the camera body for selectively causing images to be captured by the digital camera unit through the camera lens over a time period;
a printer retained by the camera body;
a display screen retained by the camera body;
wherein the image processing computer software and the computer processor are operative to process images captured by the digital camera unit over the time period to establish an image sequence comprising a plurality of images from among the images captured by the digital camera unit over the time period, wherein the image processing computer software and the computer processor are operative to create an interlaced, coded image from the plurality of images of the image sequence and to display interlaced, coded images on the display screen, wherein the interlaced, coded image comprises interlaced slices of the plurality of images of the image sequence adapted to be printed to create a printed interlaced, coded image, and wherein the printer is operative to print interlaced, coded images created by the image processing software and the computer processor from image sequences of images captured by the digital camera.

23. The system of claim 22, further comprising an image decoding panel retained atop the display screen for decoding coded images displayed on the display screen.

24. The system of claim 22, wherein the image processing computer software, the computer processor, and the display screen are operative to create and selectively display plural different interlaced, coded images based on image sequences comprising at least some different images or differently ordered images from among the images captured by the digital camera unit over the time period.

25. The system of claim 22, further comprising a viewing device for receiving a coded image produced by the image processing computer software and the computer processor from the image sequence comprising a plurality of images captured by the digital camera unit, wherein the viewing device has an image decoding panel for decoding the coded image.

26. The system of claim 25, wherein the viewing device comprises a front structure with the image decoding panel and a rear structure, wherein the front structure and the rear structure are adapted to receive printed interlaced, coded image therebetween, and wherein the viewing device further comprises a biasing mechanism for biasing printed interlaced, coded images into contact with the image decoding panel of the front structure.

27. The system of claim 22, further comprising pre-animated, pre-interlaced scenes stored in the electronic memory, wherein the image processing computer software is operative to selectively merge the pre-animated, pre-interlaced scenes with the image sequence captured by the digital camera unit.

28. The system of claim 22, wherein the printer is adapted to print interlaced, coded images from a roll of printing substrate retained by the printer.

29. The system of claim 28, further comprising first and second end caps for rotatably retaining a roll of printing substrate retained by the printer, wherein each of the first and second end caps comprises a guide surface positioned to be disposed to guide an edge of the roll of printing substrate, and further comprising an exit guide positioned to guide edges of the roll of printing substrate on exiting the printer.

30. The system of claim 22, further comprising a viewing device for receiving printed, interlaced coded images, wherein the viewing device has an image decoding panel for decoding the printed interlaced, coded images.

31. The system of claim 30, wherein the viewing device has serrated edges for permitting any protruding edges of printed interlaced, coded images to be torn away.

32. The system of claim 30, wherein the viewing device has left and right edges spaced by a given distance and wherein the image processing computer software, the computer processor, and the printer are operative to print alignment lines prior to and after printed interlaced, coded images and wherein the alignment lines are spaced in correspondence to the given distance between the left and right edges of the viewing device.
